(19) United States
(12) Patent Application Publication
(10) Pub. No.: US 2012/0272462 A1
(43) Pub. Date: Nov. 1, 2012

(54) DYES FOR POLYMER COLORATION, THEIR PREPARATION AND THEIR USE

(75) Inventors: Roxana Barbieru, Singapore (SG); Carsten Harfmann, Frankfurt Am Main (DE); Werner Russ, Florsheim-Wicker (DE)

(73) Assignee: DyStar Colours Deutschland GmbH, Frankfurt Am Main (DE)

(21) Appl. No.: 13/351,549

(22) Filed: Jan. 17, 2012

Related U.S. Application Data
(63) Continuation of application No. 13/131,958, now abandoned.

(30) Foreign Application Priority Data
Dec. 4, 2008 (EP) 08170681.4

(51) Int. Cl. C09B 1/16; C09B 1/42; C09B 1/473; C09B 1/40

(52) U.S. Cl. 8/676; 564/157; 564/154; 564/155; 564/158; 564/83; 564/82; 560/25; 564/143; 564/142; 8/675; 8/678

(57) ABSTRACT

The present invention relates to a compound of formula (I), where X, Y, T and Z are each as defined in claim 1, to its preparation and to its use.

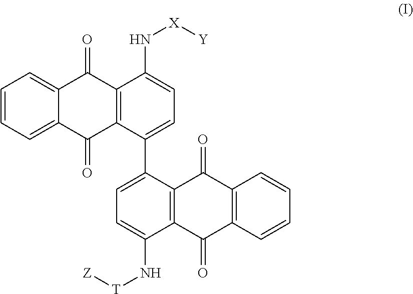

Polymers can be colored with dyes in various ways. One way is mass coloration of polymers whereby for example a pigment or a dye is mixed with the polymer and the polymer is melted to transport the dye into the polymer matrix. Other processes involve the polymer being colored, or to be more precise dyed, by the dyes diffusing into the polymer from a solution or dispersion, examples being the dyeing of polymeric fibers composed of polyester, polyacrylonitrile, polyurethane, cellulose or polyamide for example with, for example, disperse dyes, cationic dyes, acid dyes, metallized dyes or reactive dyes. The use of reactive dyes results in a covalent bond being formed between the dye and the substrate, conferring particularly high fastnesses on the dyeings/colorations. Another way to color a polymer is to add the dye to the polymer's monomers or oligomers, before the polymer is formed or as it is being formed. Dyes capable of forming covalent bonds with the polymer scaffold may likewise result in colorations of high fastness being obtained. For this, the dyes used, or to be more precise their chromophores, have to be sufficiently stable under the conditions of the polymerization.

Commercially available pigments when used in mass coloration of polymers do give colored polymers of predominantly high fastnesses, but the colorations are dull, i.e., lack transparency. Commercially available dyes for polymers are usually disperse dyes or solvent dyes and produce, when used for the coloration of polymers, colored polymers in which the dye often only has low bleed fastnesses. In addition, many of the known dyes have poor lightfastnesses or low thermal stabilities in polyolefins. Dyes having good bleed fastnesses, good lightfastnesses, good thermal stabilities as well as high saturation and transparency in polyolefins without adversely affecting the properties of the polyolefins used are not known in large numbers.

EP 0 423 068 A1, EP 0648 817 A1 and JP 2003-43680 describe dianthraquinonyl dyes which meet the above-recited requirements to some extent. However, the dyes mentioned give only a limited palette of hues and also only a limited degree of saturation when high bleed fastness is desired.

There is therefore a need for dyes which have the recited properties and thus are useful for the coloration of polyolefins.

It has now been found that dianthraquinonyl dyes which are substituted by two triazine rings constitute useful dyes for the coloration of polyolefins and other substrates. They have high stability under application conditions, are readily soluble in the polymer, or miscible with suitable organic solvents, and afford highly transparent colorations having very good fastnesses.

The present invention thus provides dyes of formula (I)

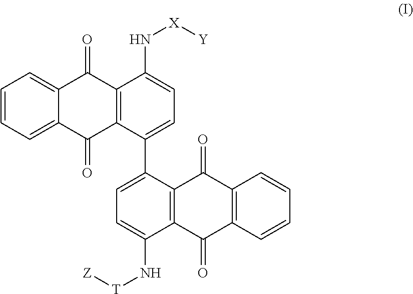

where
X and T each independently represent a group of formula (1) to (3)

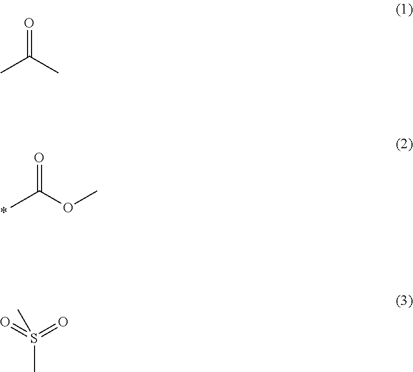

where
* indicates the bond to the —NH— group;
Y and Z each independently have one of the meanings G¹ or G²;
G¹ represents Ar; cyclo-(C₃-C₈)-alkyl; (C₁-C₃₅)-alkyl; (C₂-C₃₅)-alkyl interrupted by one or more hetero atoms; (C₁-C₃₅)-alkyl substituted by one or more of the substituents G³ to G⁶; or (C₂-C₃₅)-alkyl interrupted by one or more hetero atoms and substituted by one or more of the substituents G³ to G⁶;
G³ represents trifluoromethyl; cyclo-(C₃-C₈)-alkyl; Ar; heteroaryl; heterocycloalkyl; halogen; cyano; nitro; hydroxyl; (C₁-C₃₅)-alkoxy; Ar-oxy; (C₂-C₃₅)-acyl; Ar-carbonyl, (C₂-C₃₅)-acyloxy; Ar-carbonyloxy; (C₂-C₃₅)-acylamino; (C₁-C₃₅)-alkylsulfonylamino; Ar-sulfonylamino; Ar-carbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoAr-carbamoyl; N,N-diAr-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; Ar-oxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoAr-amino; diAr-amino; monocyclo-(C₃-C₈)-alkylmonoAr-amino; mono-(C₁-C₃₅)-alkylmonoAr-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoAr-sulfamoyl; N,N-diAr-sulfamoyl; N-monocyclo-(C₃-C₈)-alkyl-N-monoAr-sulfamoyl; N-mono-(C₁-C₃₅)-alkyl-N-monoAr-sulfamoyl; aminosulfonylamino; (C₁-C₃₅)-alkylthio; Arthio; (C₁-C₃₅)-alkylsulfonyl or Ar-sulfonyl;
G⁴ represents (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; N,N-Di-(C₂-C₃₅)-alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoarylamino; N-mono-(C₂-C₃₅)-alkyl-sulfamoyl; N,N-di-(C₂-C₃₅)-alkyl-sulfamoyl; N-mono-(C₂-C₃₅)-alkyl-N-monoAr-sulfamoyl; (C₂-C₃₅)-alkylthio or (C₂-C₃₅)-alkylsulfonyl where the alkyl radical is interrupted by one or more hetero atoms;
G⁵ represents cyclo-(C₃-C₈)-alkyl; heterocycloalkyl; (C₁-C₃₅)-alkoxy; (C₂-C₃₅)-acyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoAr-sulfamoyl; N-mono-(C₁-C₃₅)-alkyl-N-monoAr-sulfamoyl; (C₁-C₃₅)-alkylthio or (C₁-C₃₅)-alkylsulfonyl where the alkyl radical is substituted by a G⁷ radical;
G⁶ represents G⁴ where the alkyl radical is substituted by a G⁷ radical;
G⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoarylamino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoarylsulfamoyl; N,N-diarylsulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl; (C₂-C₃₅)-alkylsulfonyl whose alkyl group is substituted by one or more heteroatoms; or represents arylsulfonyl;
G² represents (C₁-C₃₅)-alkyl or (C₂-C₃₅)-alkyl interrupted by one or more heteroatoms, where the alkyl group is in each case substituted by a group of formula (4)

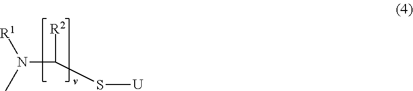

where
R¹ represents hydrogen; aryl; (C₁-C₃₅)-alkyl; (C₂-C₃₅)-alkyl interrupted by one or more hetero atoms; (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl; monohydroxy-(C₁-C₃₅)-alkyl; polyhydroxy-(C₂-C₃₅)-alkyl; (C₁-C₃₅)-alkoxyalkyl or aryloxy-(C₁-C₃₅)-alkyl;
R² represents hydrogen, (C₁-C₃₅)-alkyl, singly or multiply oxygen-interrupted (C₂-C₃₅)-alkyl, aryl, aryl-(C₁-C₃₅)-alkyl, (C₁-C₃₅)-alkyl-aryl, aryloxy, (C₁-C₃₅)-alkoxy, monohydroxy-(C₁-C₃₅)-alkyl or polyhydroxy-(C₂-C₃₅)-alkyl; and has identical or different meanings within a molecule of formula (I);
v represents a number from 1 to 35;
S represents a group of formula (5)

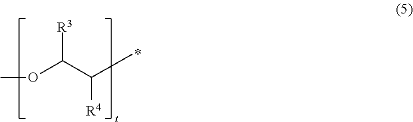

where
* indicates the bond to the U group;
t represents a rational number from 0 to 200 and has identical or different meanings within a molecule of formula (I); and
R³ and R⁴ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)-alkyl;
where R³ and R⁴ each have identical or different meanings within a molecule of formula (I); and where when R³ and R⁴ have different meanings within a molecule of formula (I) these different meanings are randomly distributed or regions of respectively identical meanings follow each other;
U represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
where, in the groups G¹ to G⁶, Ar represents a group of formula (6) or (7)

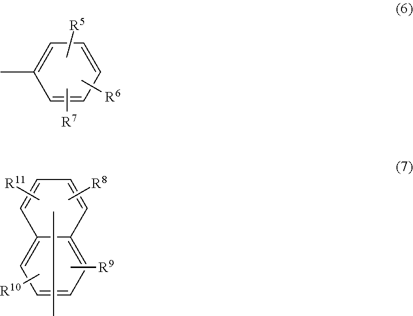

where
R⁵ to R¹¹ each independently have one of the meanings G⁸ to G¹¹ or represent a group of formula (8)

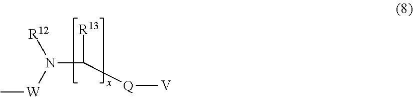

where
W represents a group of formula (1), (3) or (9)

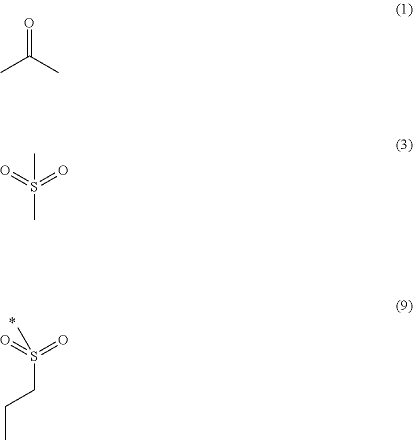

and * indicates the bond to the —NR¹² group;
R¹² represents hydrogen, aryl, (C₁-C₃₅)-alkyl, (C₂-C₃₅)-alkyl interrupted by one or more hetero atoms, (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl monohydroxy-(C₁-C₃₅)-alkyl, polyhydroxy-(C₂-C₃₅)-alkyl, (C₁-C₃₅)-alkoxyalkyl or aryloxy-(C₁-C₃₅)-alkyl;
R¹³ represents hydrogen, (C₁-C₁₅)-alkyl, singly or multiply oxygen-interrupted (C₂-C₁₅)-alkyl, aryl, aryl-(C₁-C₁₅)-alkyl, (C₁-C₁₅)-alkyl-aryl, aryloxy, (C₁-C₁₅)-alkoxy, monohydroxy-(C₁-C₁₅)-alkyl or polyhydroxy-(C₂-C₁₅)-alkyl and can have identical or different meanings within a molecule of formula (I);
x represents a number from 1 to 35;
V represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
Q represents a group of formula (10)

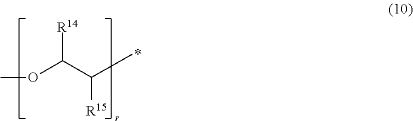

where
* indicates the bond to the V group;
R¹⁴ and R¹⁵ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)alkyl and have identical or different meanings within a molecule of formula (I) and where when R¹⁴ and R¹⁵ have different meanings within a molecule of formula (I) these different meanings are randomly distributed or regions of respectively identical meanings follow each other;
r represents a rational number from 0 to 200 and has identical or different meanings within a molecule of formula (I);
G⁸ represents hydrogen, (C₁-C₃₅)-alkyl; trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino, di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl;
G⁹ represents (C₂-C₃₅)-alkyl; (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; N,N-di-(C₂-C₃₅)-alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoaryl-amino; N-mono-(C₂-C₃₅)-alkyl-sulfamoyl; N,N-di-(C₂-C₃₅)-alkyl-sulfamoyl; N-mono-(C₂-C₃₅)-alkyl-N-monoarylsulfamoyl; (C₂-C₃₅)-alkylthio or (C₂-C₃₅)-alkylsulfonyl where the alkyl radical is interrupted by one or more hetero atoms or one or more hetero atom groups;
G¹⁹ represents (C₁-C₃₅)-alkyl; cyclo-(C₃-C₈)-alkyl; heterocycloalkyl; (C₁-C₃₅)-alkoxy; (C₂-C₃₅)-acyl; cyclo-(C₃-C₈)-alkylcarbonyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoarylsulfamoyl; N-mono-(C₁-C₃₅)-alkyl-N-monoarylsulfamoyl; (C₁-C₃₅)-alkylthio or (C₁-C₃₅)-alkylsulfonyl where the alkyl radical is substituted by one or more G⁷ substituents;
G¹¹ represents G⁹ where the alkyl radical is substituted by one or more G⁷ substituents;
where, in the groups G⁷ to G¹¹, aryl represents a group of formula (11) or (12)

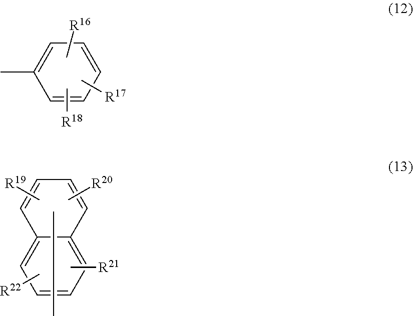

where
R¹⁶ to R²² each independently represent the G¹² group; and
G¹² represents hydrogen; (C₁-C₁₈)-alkyl; monohydroxy-(C₁-C₁₈)-alkyl; polyhydroxy-(C₂-C₁₈)-alkyl; (C₂-C₁₈)-alkyl interrupted by one or more oxygen atoms; trifluoromethyl; cyclo-(C₃-C₈)-alkyl; heteroaryl; heterocycloalkyl; halogen; cyano; nitro; hydroxyl; (C₁-C₁₈)-alkoxy; (C₂-C₁₈)-acyl; cyclo-(C₃-C₈)-alkylcarbonyl, (C₂-C₁₈)-acyloxy; (C₂-C₁₈)-acylamino; (C₁-C₁₈)-alkylsulfonylamino; carbamoyl; N-monocyclo-(C₃-C₈)-alkyl-carbamoyl; N-mono-(C₁-C₁₈)-alkyl-carbamoyl; N,N-dicyclo-(C₃-C₈)-alkyl-carbamoyl; N,N-di-(C₁-C₁ₐ)-alkyl-carbamoyl; (C₁-C₁₈)-alkoxycarbonyl; amino; monocyclo-(C₃-C₈)-alkyl-amino; mono-(C₁-C₁₈)-alkyl-amino; di(cyclo)-(C₃-C₈)-alkyl-amino; di-(C₁-C₁₈)-alkyl-amino; aminothiocarbonylamino; aminocarbonylamino; sulfamoyl; N-monocyclo-(C₃-C₈)-alkyl-sulfamoyl; N-mono-(C₁-C₁₈)-alkyl-sulfamoyl; N,N-dicyclo-(C₃-C₈)-alkyl-sulfamoyl; N,N-di-(C₁-C₁₈)-alkyl-sulfamoyl; aminosulfonylamino; (C₁-C₁₈)-alkylthio or (C₁-C₁₈)-alkylsulfonyl;
where
when X and T both represent a group of formula (1),
Y and Z do not both represent (C₁-C₃₅)-alkyl; a group of formula (6) where R⁵, R⁶ and R⁷ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino, (C₁-C₃₅)-alkylthio, (C₂-C₃₅)-acyl, benzoylamino or benzenesulfonylamino; or a methyl or ethyl group substituted by a group of formula (7) where R⁴, R⁵ and R⁶ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino or (C₁-C₃₅)-alkylthio; and it is not the case that one of Y and Z represents (C₁-C₃₅)-alkyl and the other represents hydrogen; and
when X and T both represent a group of formula (2),
Y and Z do not both represent (C₁-C₃₅)-alkyl; (C₁-C₃₅)-alkyl substituted by halogen, (C₁-C₃₅)-alkylsulfonyl, substituted or unsubstituted benzenesulfonyl, or a group of formula (6) where R⁵, R⁶ and R⁷ independently represent hydrogen, halogen, (C₁-C₃₅)-alkyl or (C₁-C₃₅)-alkoxy; a group of formula (6) where R⁵, R⁶ and R⁷ each independently represent hydrogen, halogen, nitro, cyano, (C₁-C₃₅)-alkyl, (C₁-C₃₅)-alkoxy or aryl; or substituted or unsubstituted benzoyl; and
when X and T both represent a group of formula (3),
Y and Z do not both represent a group of formula (6) where R⁵, R⁶ and R⁷ each independently represent hydrogen, halogen, nitro, (C₁-C₃₅)-alkyl, (C₁-C₃₅)-alkoxy; (C₂-C₃₅)-acyl, benzoylamino or benzenesulfonylamino.

In the abovementioned definitions, alkyl groups may be straight chain or branched and be for example methyl, ethyl, n-propyl, isopropyl, n-butyl or isobutyl, but also hexyl, such as n-hexyl, heptyl, such as n-heptyl, octyl, such as n-octyl and isooctyl, nonyl, such as n-nonyl, decyl, such as n-decyl, dodecyl, such as n-dodecyl, hexadecyl, such as n-hexadecyl, or octadecyl, such as n-octadecyl. The same holds mutatis mutandis for alkoxy and alkylthio groups.

When alkyl groups are interrupted by one or more hetero atoms, hetero atoms are oxygen, sulfur, sulfonyl, carboxyl and also the group —NR²³, where R²³ represents (C₁-C₆)-alkyl, monohydroxy-(C₁-C₆)-alkyl, polyhydroxy-(C₂-C₆)-alkyl, (C₁-C₄)-alkyloxy-(C₁-C₆)-alkyl, phenoxy-(C₁-C₆)-alkyl or phenyl.

Cycloalkyl groups are in particular cyclopropyl, cyclobutyl, cyclopentyl, cyclohexyl, cycloheptyl and cyclooctyl.

Heterocycloalkyl has in particular 3 to 8 ring members and preferably represents pyrrolidine, piperidine, morpholine or piperazine.

Heteroaryl has in particular 5 or 6 ring members and is preferably pyridine, pyrimidine, pyridazine, pyrazine, pyrrole, imidazole, pyrazole, 1,2,4-thiadiazole, 1,2,4-triazole, tetrazole, thiophene, thiazole, isothiazole, 1,3,4-thiadiazole, furan, oxazole or isoxazole.

Halogen is in particular fluorine, chlorine or bromine.

Particularly preferred dyes of formula (I) according to the present invention conform to formula (Ia)

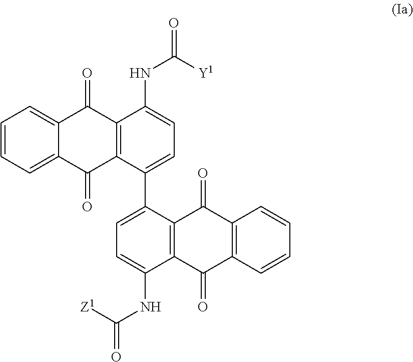

where
Y¹ and Z¹ each independently represent Ar¹; cyclo-(C₃-C₈)-alkyl; (C₁-C₃₅)-alkyl; (C₂-C₃₅)-alkyl interrupted by one or more oxygen or sulfur atoms; (C₁-C₃₅)-alkyl substituted by one or more G¹³ to G¹⁶ substituents; (C₂-C₃₅)-alkyl interrupted by one or more oxygen or sulfur atoms and substituted by one or more G¹³ to G¹⁶ substituents;
G¹³ represents cyclo-(C₅-C₆)-alkyl; aryl; heterocycloalkyl having 5 or 6 ring members; halogen; cyano; hydroxyl; (C₁-C₁₈)-alkoxy; aryloxy; (C₂-C₁₈)-acyl, arylcarbonyl; (C₂-C₃₅)-acylamino; (C₁-C₃₅)-alkylsulfonylamino; arylsulfonylamino; arylcarbonylamino; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; aminosulfonylamino; (C₁-C₃₅)-alkylthio; arylthio; (C₁-C₃₅)-alkylsulfonyl or arylsulfonyl;
G¹⁴ represents (C₂-C₁₈)-alkoxy; (C₂-C₁₈)-acyl, (C₂-C₃₅)-acylamino; (C₂-C₃₅)-alkylsulfonylamino; mono-(C₂-C₃₅)-alkyl-amino; di-(C₂-C₃₅)-alkyl-amino; mono-(C₂-C₃₅)-alkylmonoaryl-amino; (C₂-C₃₅)-alkylthio; or (C₂-C₃₅)-alkylsulfonyl where the alkyl radical is interrupted by one or more heteroatoms;
G¹⁵ represents cyclo-(C₅-C₆)-alkyl; aryl; heterocycloalkyl having 5 or 6 ring members; (C₁-C₁₈)-alkoxy; (C₂-C₁₈)-acyl, (C₂-C₃₅)-acylamino; (C₁-C₃₅)-alkylsulfonylamino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; (C₁-C₃₅)-alkylthio; or (C₁-C₃₅)-alkylsulfonyl where the alkyl radical is substituted by a G¹⁷ substituent;
G¹⁶ represents G¹⁴ where the alkyl radical is substituted by a G¹⁷ radical;
G¹⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl, (C₂-C₃₅)-alkylsulfonyl whose alkyl group is substituted by one or more heteroatoms or represents arylsulfonyl;
Ar¹ represents a group of formula (6a) or (7a)

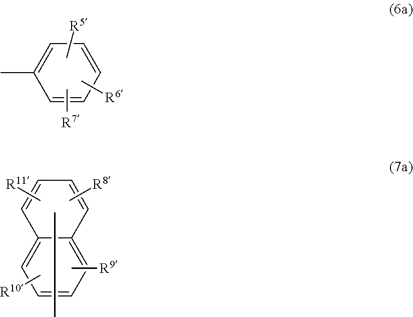

where
R^{5′} to R^{11′} each independently represent hydrogen; (C₁-C₃₅)-alkyl; cyclo-(C₃-C₈)-alkyl; aryl; heteroaryl; heterocycloalkyl; halogen; cyano; nitro; hydroxyl; (C₁-C₃₅)-alkoxy, aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl or a substituent of formula (8a)

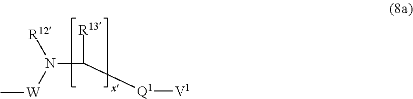

where
W is as defined above;
R^{12′} represents hydrogen, (C₂-C₃₅)-acyl; cyclo(C₃-C₈)-alkylcarbonyl, arylcarbonyl, (C₁-C₃₅)-alkylsulfonyl or arylsulfonyl;

R^{13′} represents hydrogen or (C₁-C₁₅)-alkyl and has identical or different meanings within a molecule of formula (Ia);

x′ represents a number from 1 to 10;
V¹ represents hydrogen, (C₁-C₃₅)-alkyl, aryl, aryloxy, (C₁-C₃₅)-alkoxy or (C₁-C₃₅)-alkyl-aryloxy;
Q¹ represents a group of formula (10a)

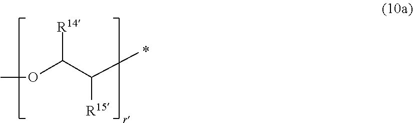

where
* indicates the bond to the V¹ group;
R^{14′} and R^{15′} each independently represent hydrogen or (C₁-C₃₅)-alkyl and have identical or different meanings within a molecule of formula (Ia) and where when R^{14′} and R^{15′} have different meanings within a molecule of formula (Ia) these different meanings are randomly distributed or regions of respectively identical meanings follow each other;
r′ represents a rational number from 0 to 100 and has identical or different meanings within a molecule of formula (Ia); and
aryl is as defined above.

In particularly preferred dyes of formula (Ia), Y¹ and Z¹ each independently represent (C₈-C₂₀)-alkyl; cyclopentyl; cyclohexyl or (C₁-C₄)-alkyl substituted by a substituent selected from the group consisting of chlorine, cyclopentyl, cyclohexyl, (C₁-C₄)-alkoxy, (C₆-C₂₀)-alkylamino, (C₆-C₂₀)-alkylamino interrupted by an S or an O, (C₁-C₄)-alkylamino where the alkyl radical is substituted by (C₁-C₁₈)-alkylsulfonyl whose alkyl group is interrupted by an NH group, (C₆-C₂₀)-alkylthio, cyclohexyl-(C₁-C₄)-alkylamino, phenyl-(C₁-C₄)-alkoxy, phenyl-(C₁-C₄)-alkylamino, (C₁-C₄)-alkoxy-(C₁-C₄)-alkylamino, a group of formula (14)

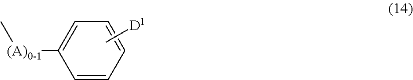

where
A represents —O—, —S—, —NH— or —NHCH₂CH₂—; and
D represents hydrogen; (C₁-C₁₈)-alkyl; a group of formula —O—(CH₂)ₙ—SO₂—(CH₂)ₘ—OH where n and m each independently represent a whole number from 1 to 4; a group of formula —SO₂—CH₂CH₂OH; and a group of formula (6a′)

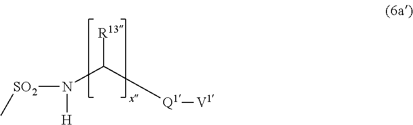

where
R^{13″} represents hydrogen or methyl;
V^{1′} represents hydrogen or (C₁-C₄)-alkoxy;
x″ represents a number from 1 to 12;
Q^{1′} represents a group of formula (10a′)

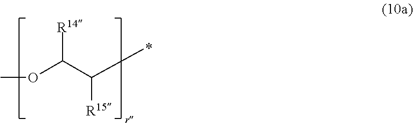

where
* indicates the bond to the V′ group;
R^{14″} and R^{15″} each independently represent hydrogen or methyl; and
r″ represents a number from 0 to 10;
or
Y¹ and Z¹ each independently represent phenyl; naphthalene; or phenyl substituted by phenyl, phenyl-(C₁-C₄)-alkoxy or (C₁-C₃₅)-alkylsulfonyl whose alkyl group is interrupted by an NH group or an NH group and 2 to 12 oxygen atoms.

Examples of dyes of formula (Ia) are the dyes of formulae (Ia1) to (Ia39)

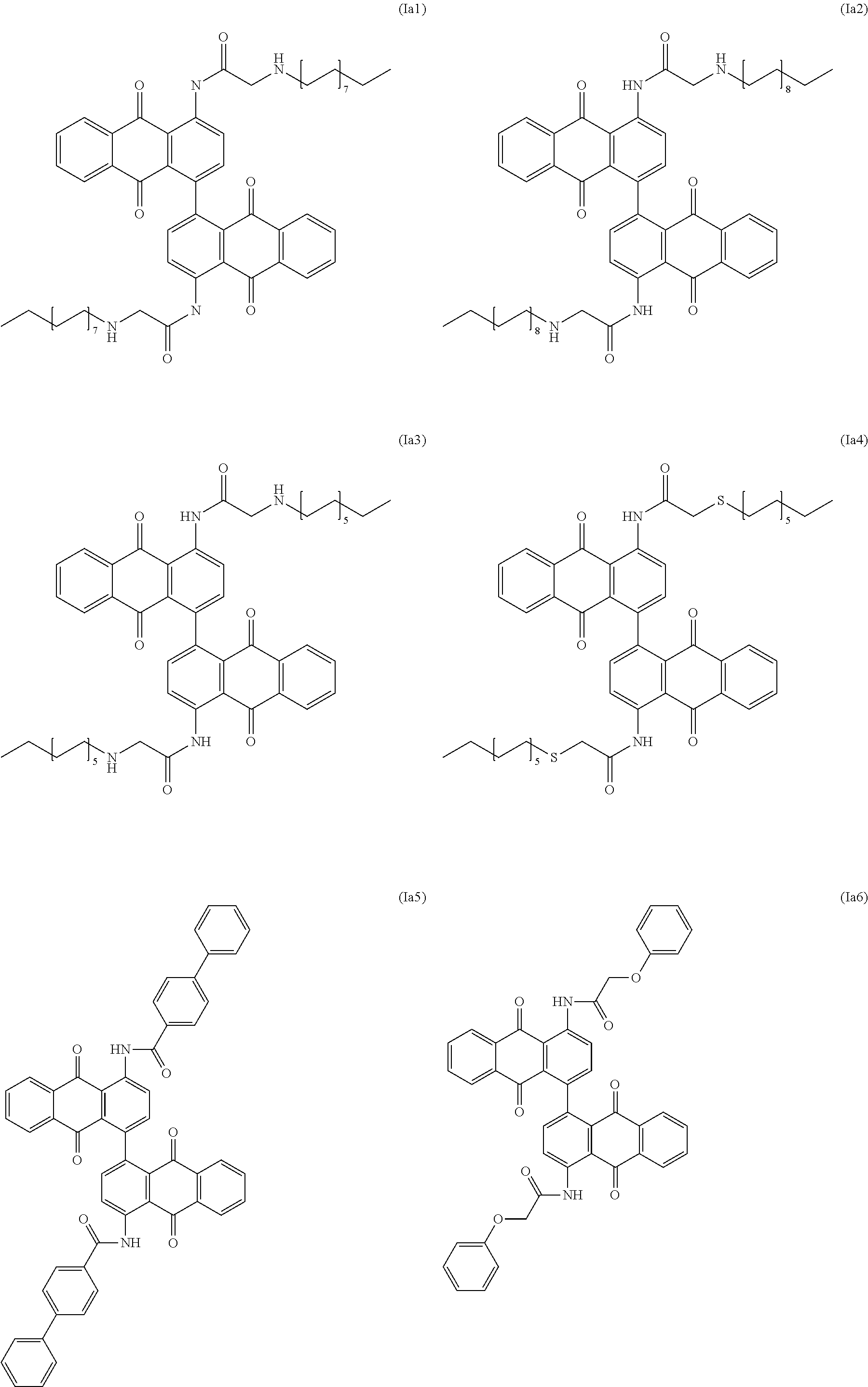

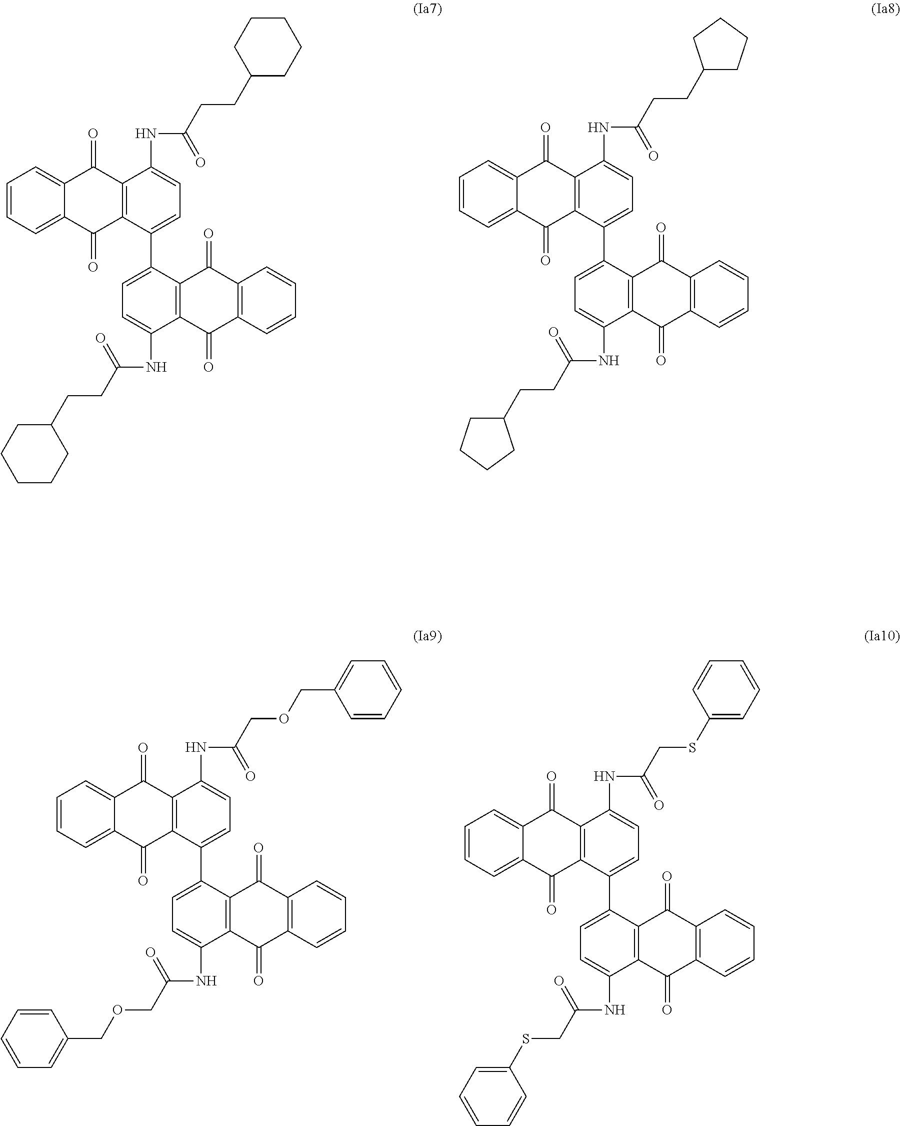

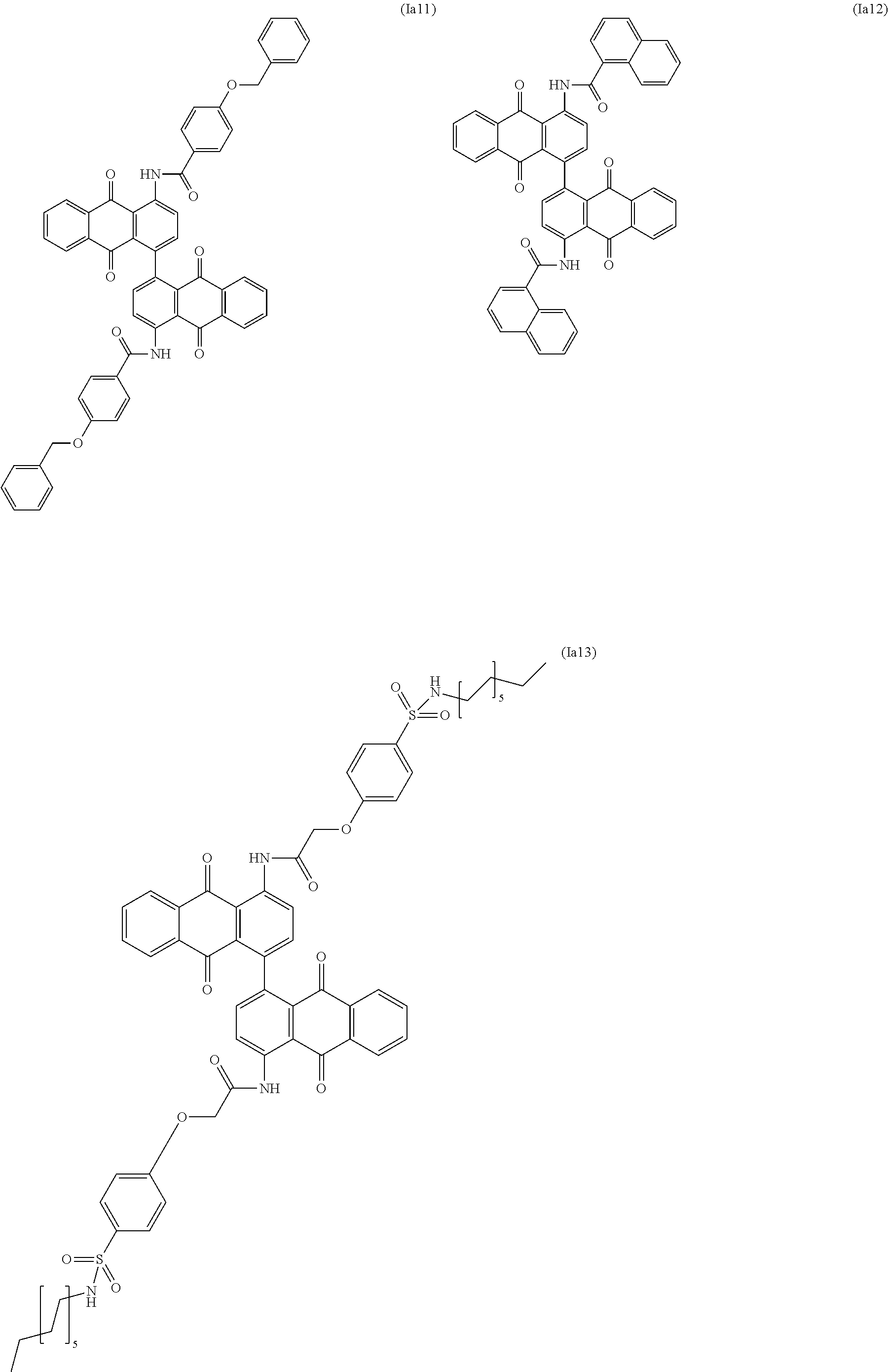

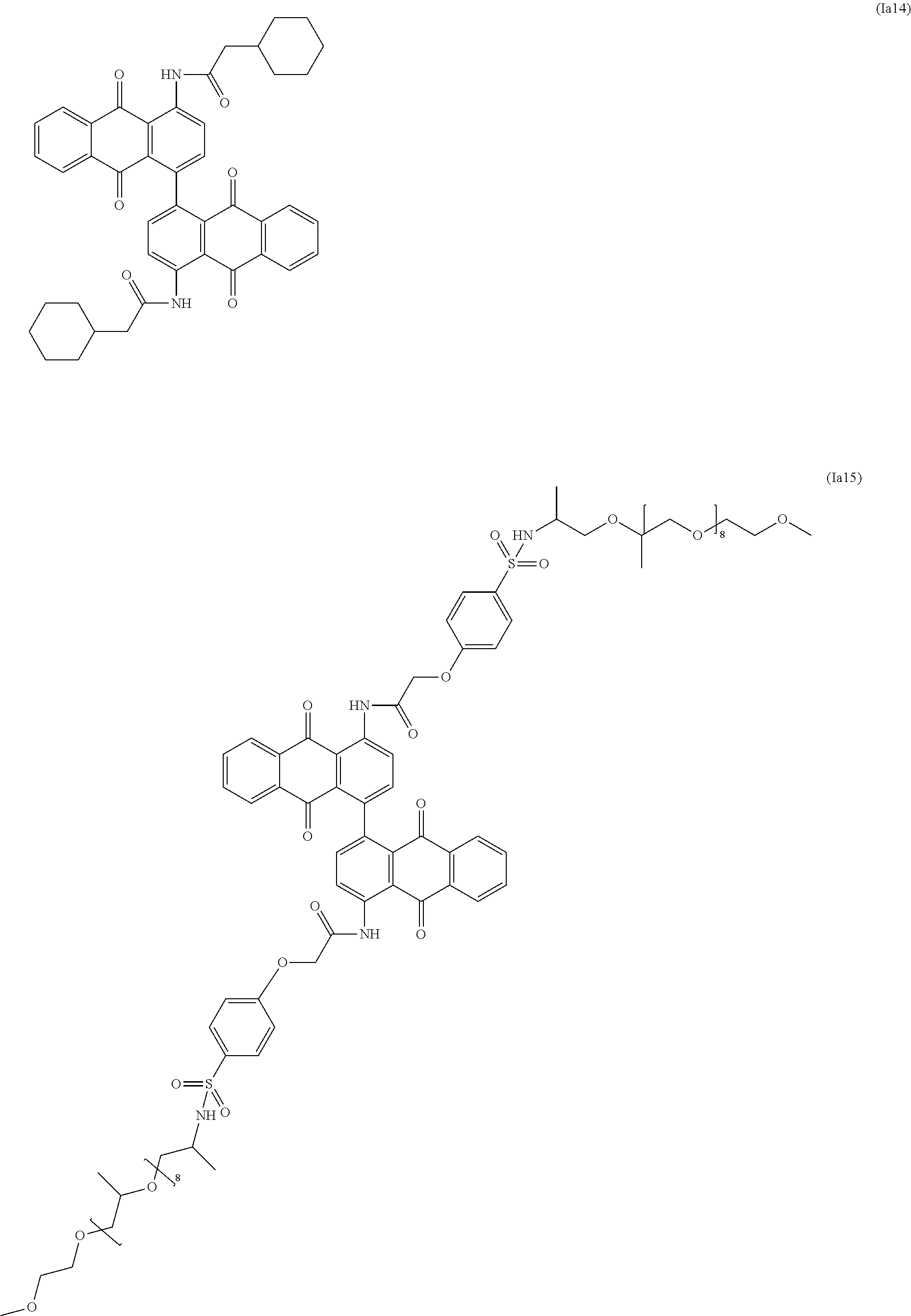

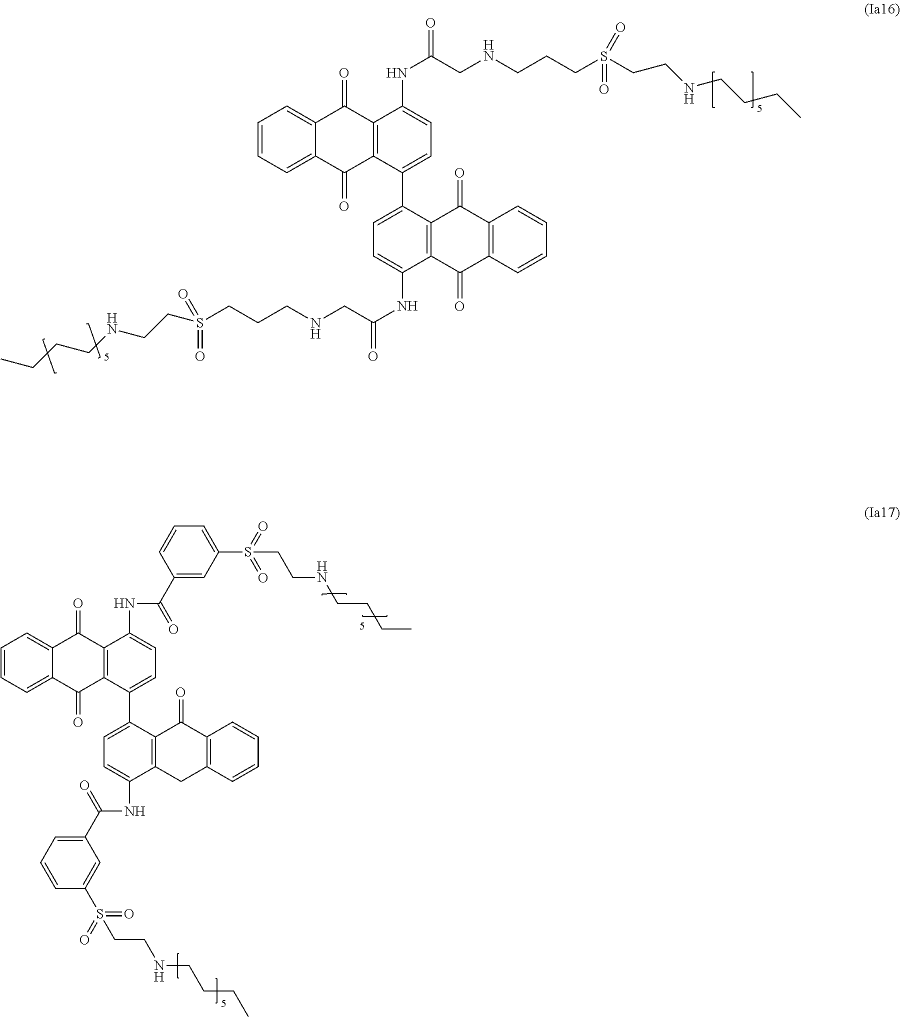

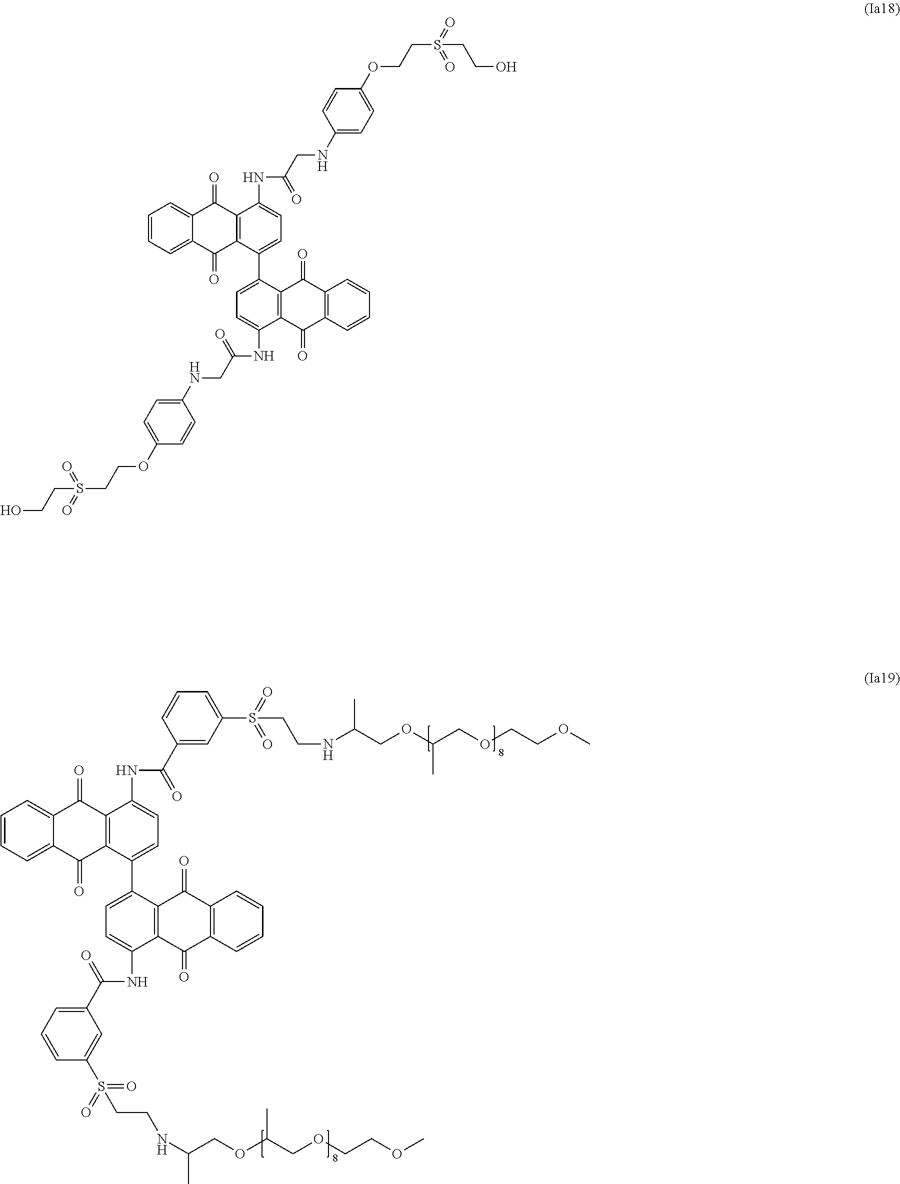

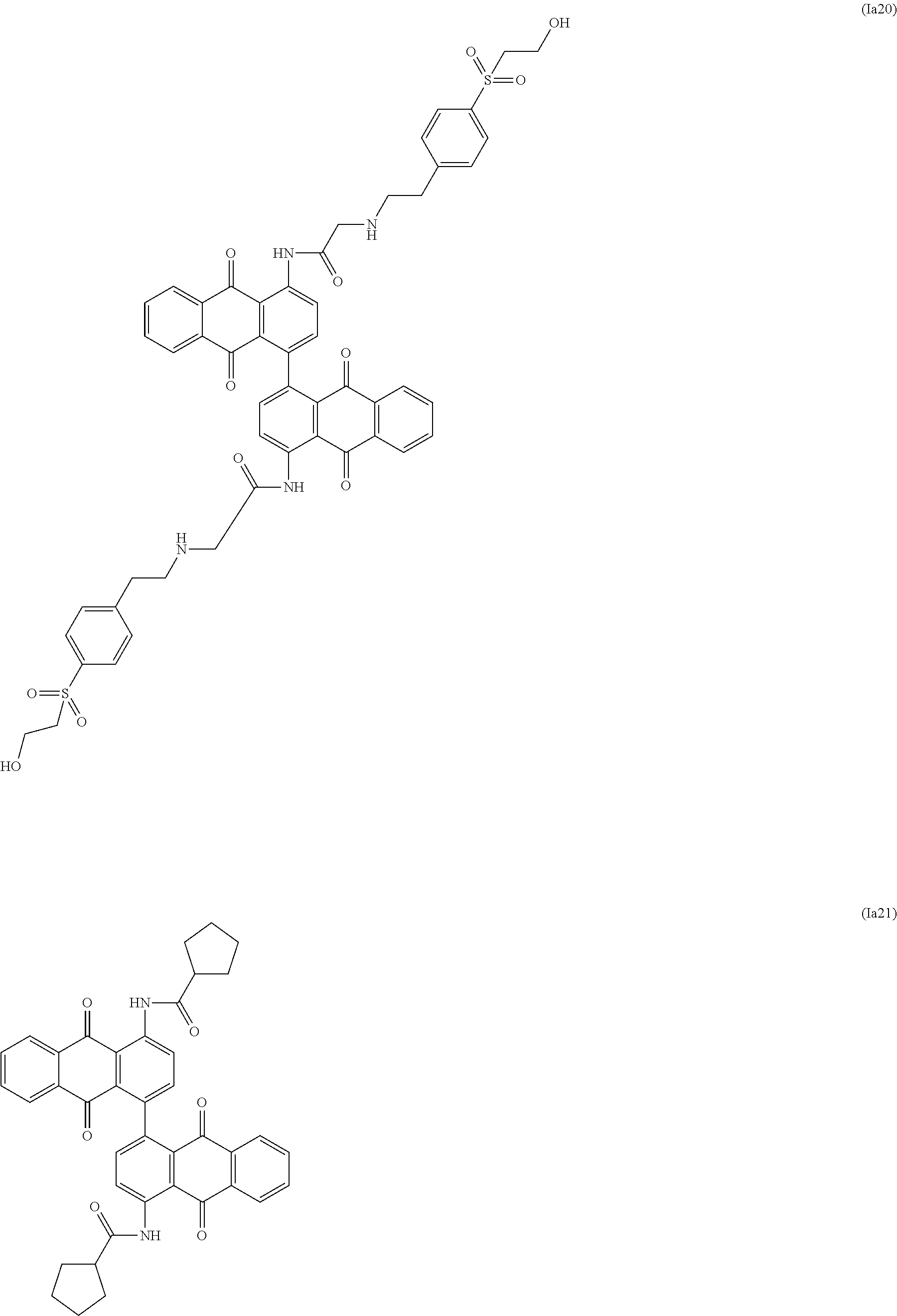

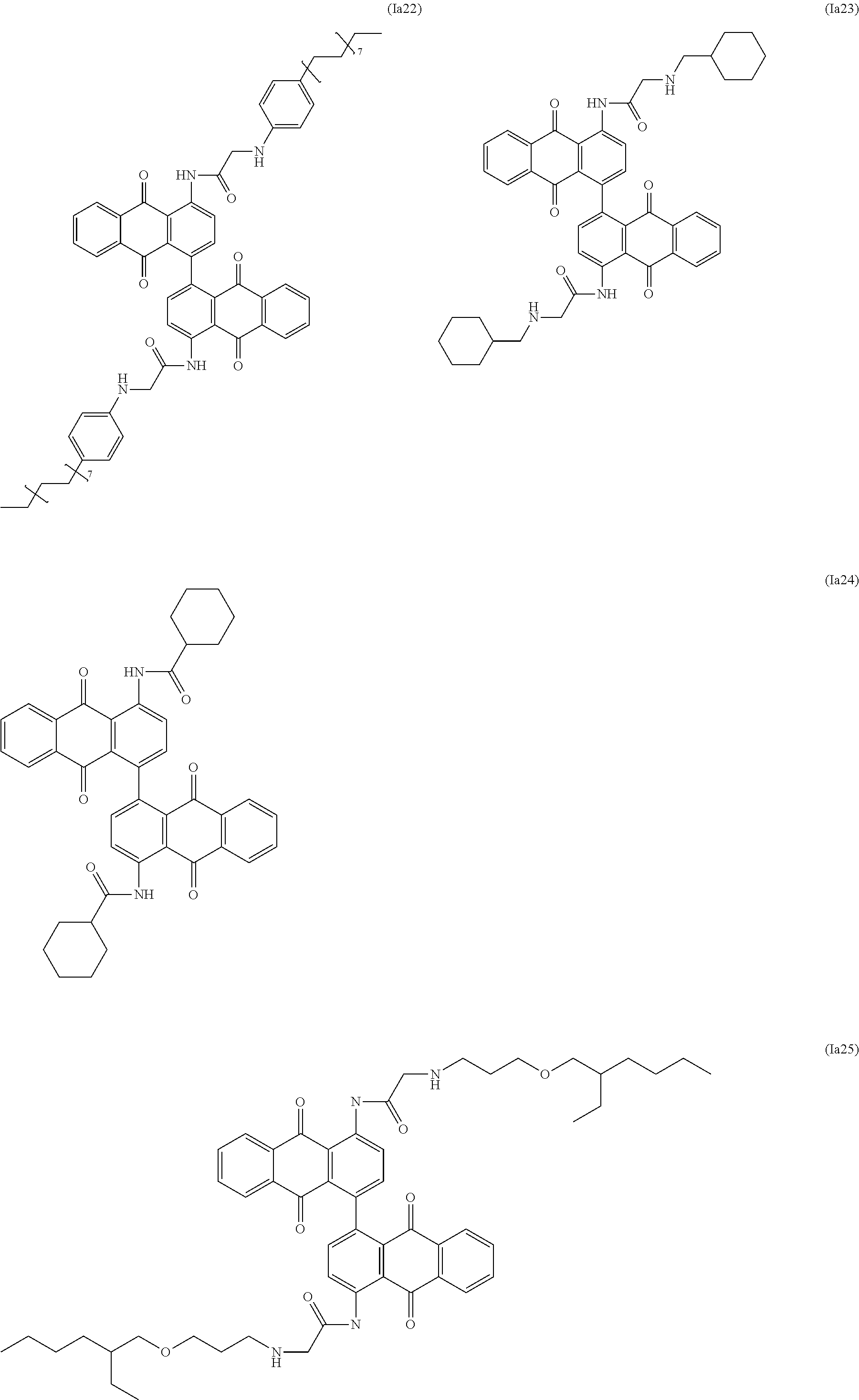

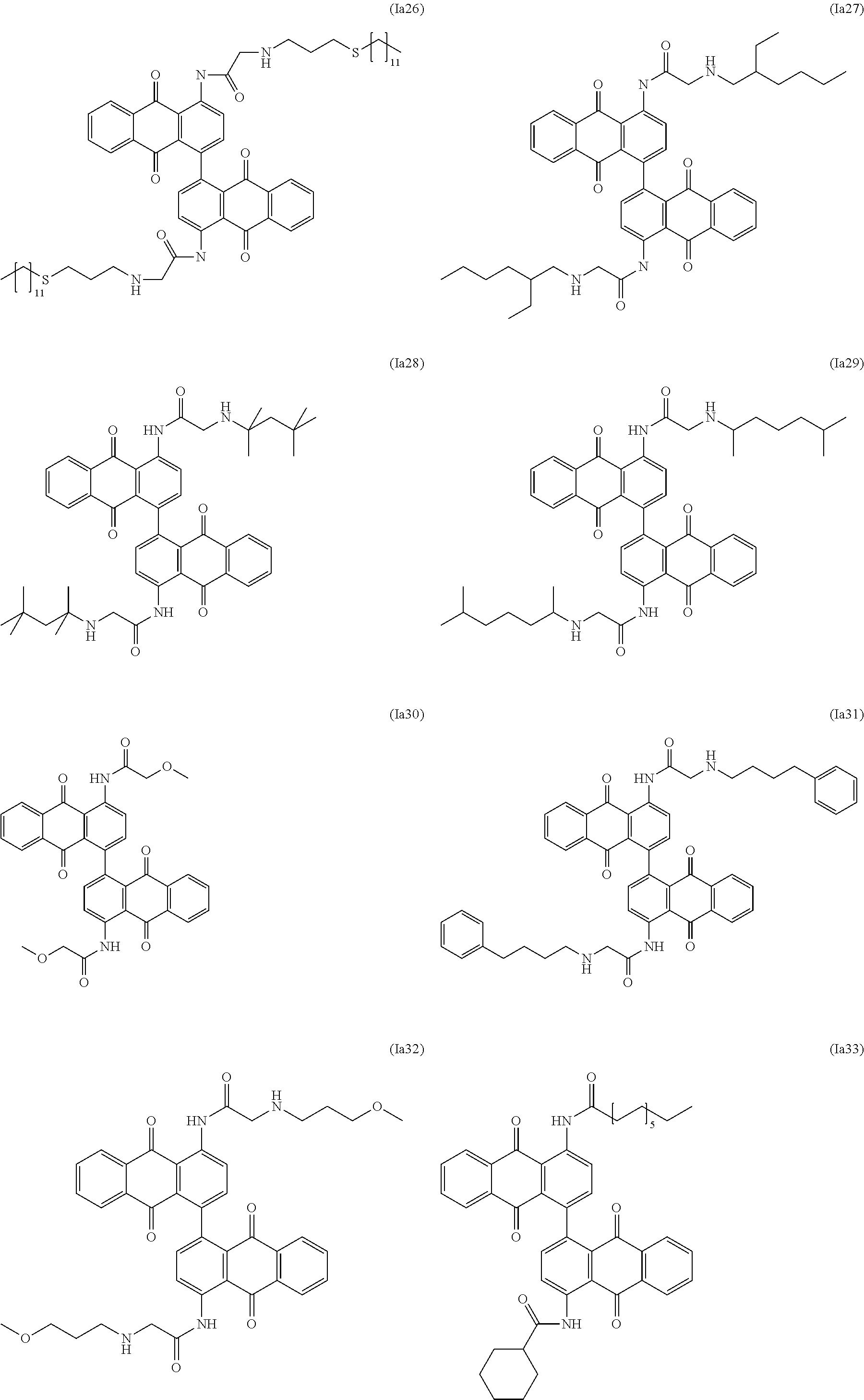

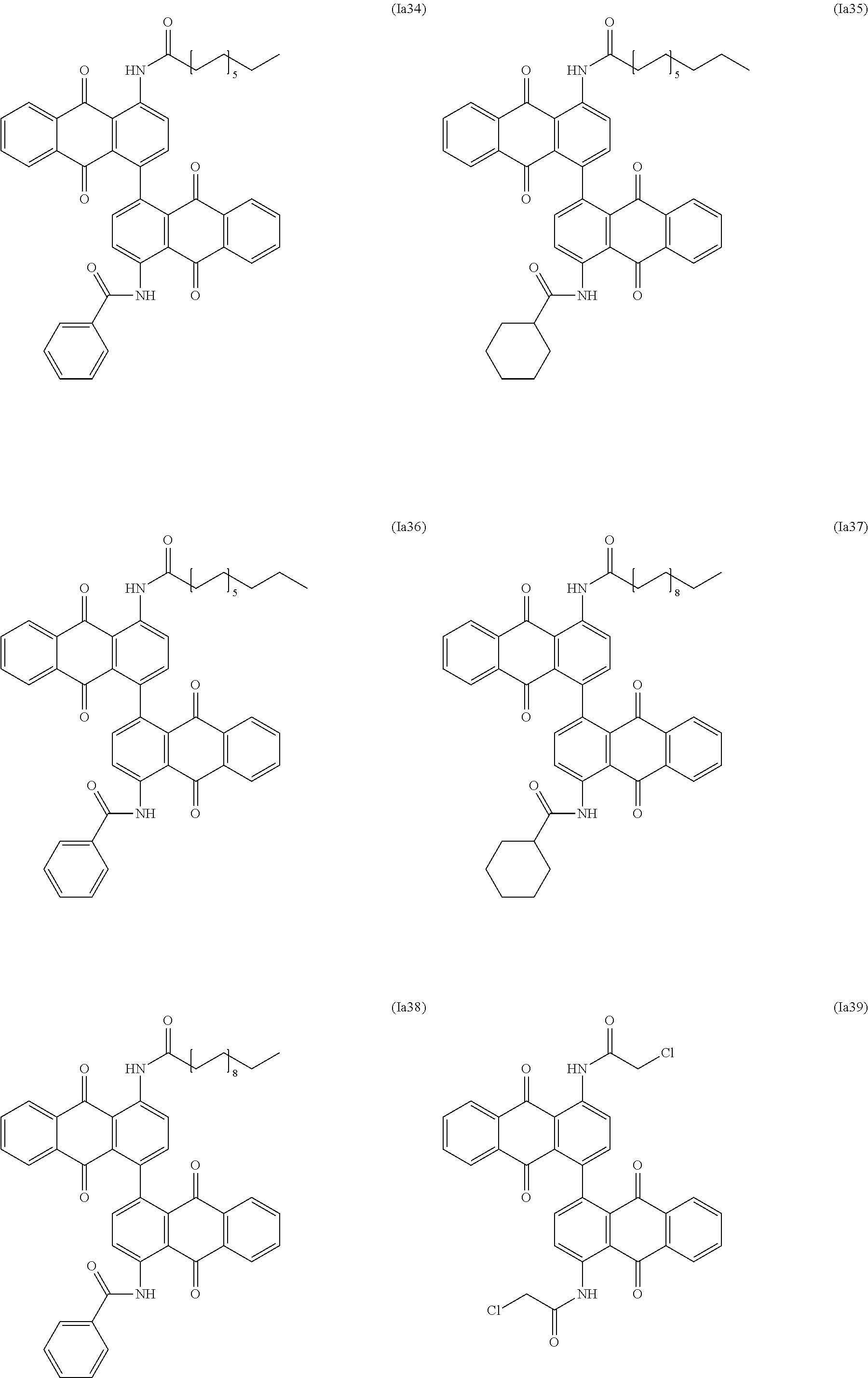

Further particularly preferred dyes of formula (I) according to the present invention conform to formula (Ib)

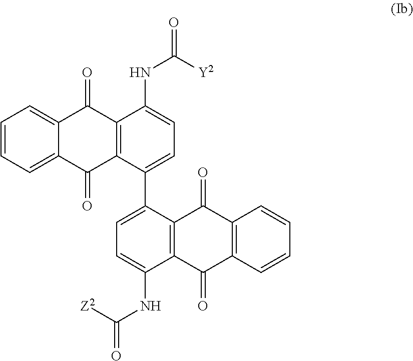

where
Y² and Z² each independently represent (C₁-C₃₅)-alkyl or (C₂-C₃₅)-alkyl interrupted by one or more heteroatoms, where in each case the alkyl group is substituted by a group of formula (4a)

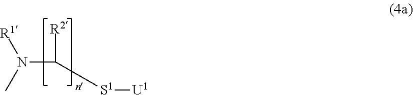

where
R^{1′} represents hydrogen or (C₁-C₃₅)-alkyl;
R^{2′} represents hydrogen or (C₁-C₃₅)-alkyl and has identical or different meanings within a molecule of formula (Ib);
v′ represents a number from 1 to 10;
S¹ represents a group of formula (5a):

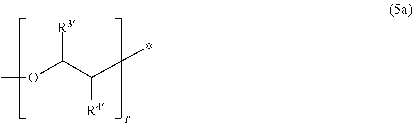

where
* indicates the bond to the U¹ group;
t′ represents a rational number from 0 to 100 and has identical or different meanings within a molecule of formula (Ib);
R^{3′} and R^{4′} each independently represent hydrogen or (C₁-C₃₅)-alkyl; where R^{3′} and
R^{4′} each have identical or different meanings within a molecule of formula (Ib); and where when R^{3′} and R^{4′} have different meanings within a molecule of formula (Ib) these different meanings are randomly distributed or regions of respectively identical meanings follow each other; and
U¹ represents hydrogen, (C₁-C₃₅)-alkyl, aryl, aryloxy, (C₁-C₃₅)-alkoxy, or (C₁-C₃₅)-alkyl-aryloxy.

In particularly preferred dyes of formula (Ib), Y² and Z² each independently represent (C₁-C₆)-alkyl or (C₂-C₆)-alkyl interrupted by an —NH— group and an —SO₂— group, the alkyl group in each case being substituted by a group of formula (4a) where

R^{1′} represents hydrogen;
R^{2′} represents hydrogen or methyl;
v′ represents 1;
t′ represents a number from 1 to 20;
R^{3′} and R^{4′} each independently represent hydrogen or methyl; where R^{3′} and R^{4′} each have identical or different meanings within a molecule of formula (Ib); and where when R^{3′} and R^{4′} have different meanings within a molecule of formula (Ib), these different meanings are randomly distributed or regions of respectively identical meanings follow each other; and
U¹ represents (C₁-C₁₂)-alkoxy or phenoxy substituted by (C₅-C₁₀)-alkyl.

Examples of dyes of formula (Ib) are the dyes of formulae (Ib1) to (Ib4)

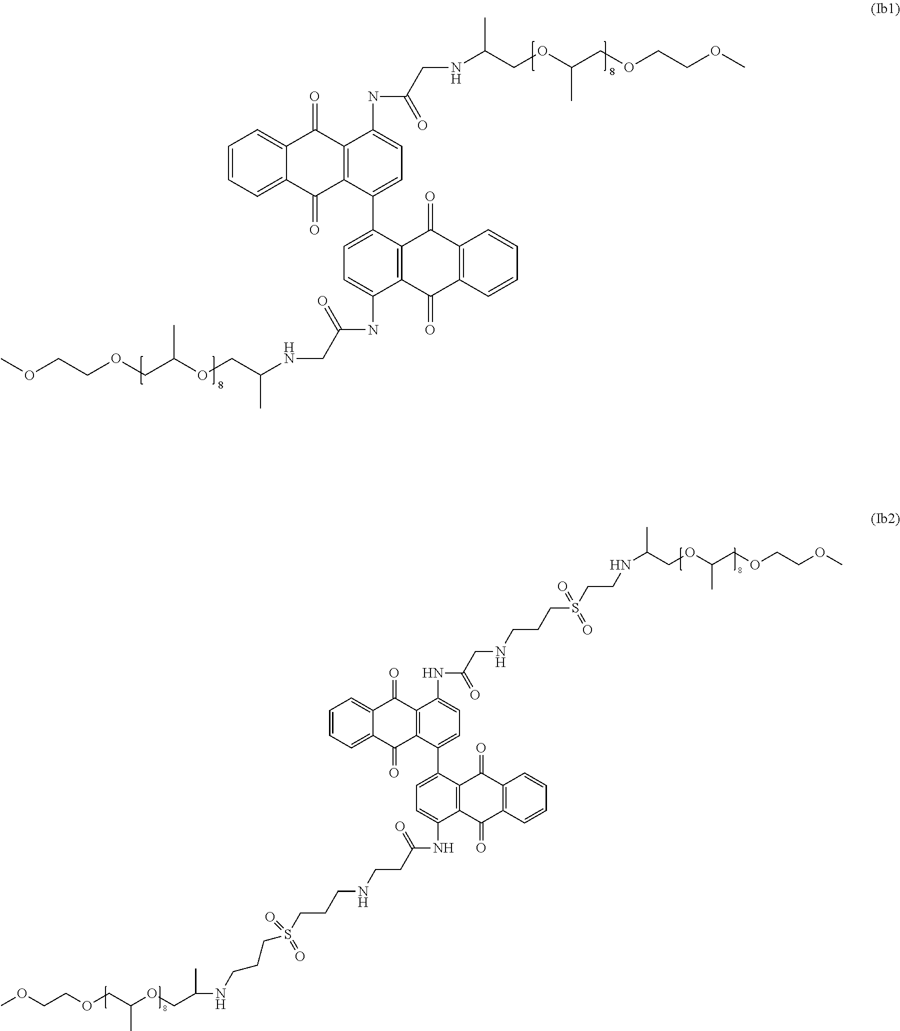

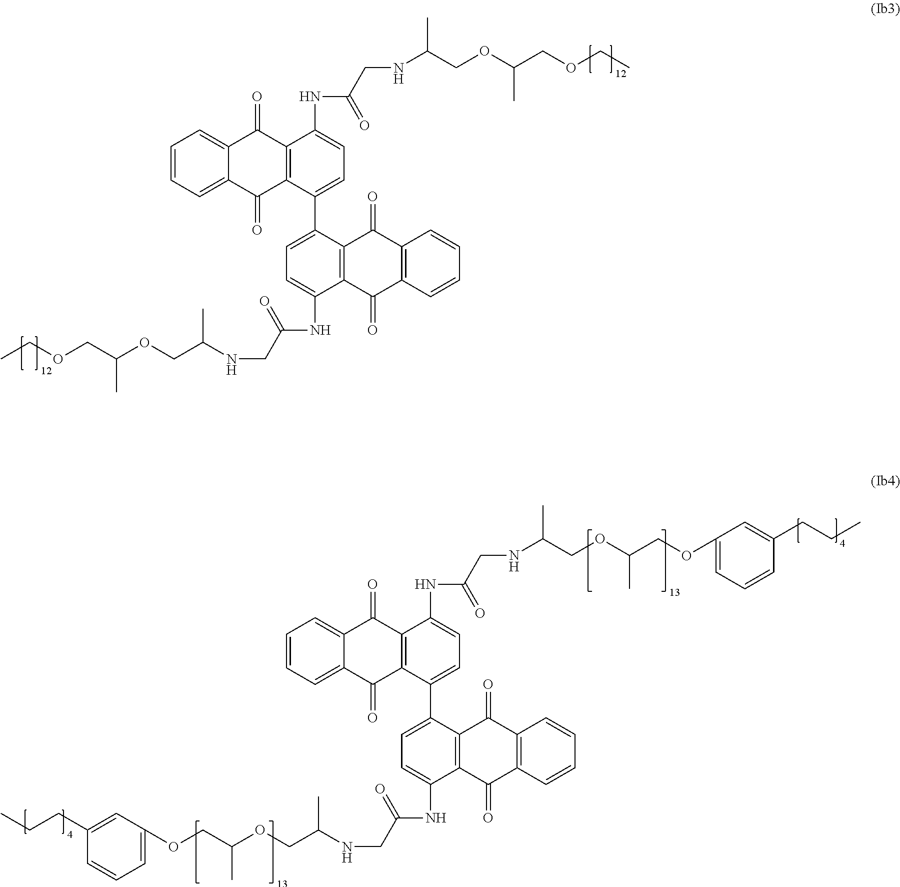

Further particularly preferred dyes of formula (I) according to the present invention conform to formula (Ic)

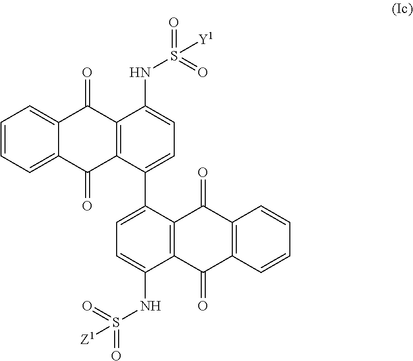

where Y¹ and Z¹ are each as defined above.

In particularly preferred dyes of formula (Ic), Y¹ and Z¹ each independently represent phenyl substituted by acetylamino, (C₁-C₆)-alkyl, (C₁-C₄)-alkoxy, trifluoromethyl or phenyl; (C₁-C₁₀)-alkyl; cyclohexyl; or (C₁-C₄)-alkyl substituted by phenyl, (C₄-C₁₈)-alkylamino, (C₁-C₄)-alkoxy-phenoxy or by a group of formula (4a)

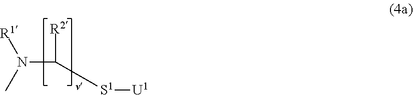

where
R^{1′} represents hydrogen;
R^{2′} represents hydrogen or methyl;
v′ represents 1;
S¹ represents a group of formula (5a):

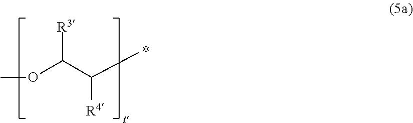

where
* indicates the bond to the U¹ group;
t′ represents a number from 1 to 20;
R^{3′} and R^{4′} each independently represent hydrogen or methyl; where R^{3′} and R^{4′} each have identical or different meanings within a molecule of formula (Ic); and where when R^{3′} and R^{4′} have different meanings within a molecule of formula (Ic), these different meanings are randomly distributed or regions of respectively identical meanings follow each other; and
U¹ represents (C₁-C₁₂)-alkoxy.

Examples of dyes of formula (Ic) are the dyes of formulae (Ic1) to (Ic13):

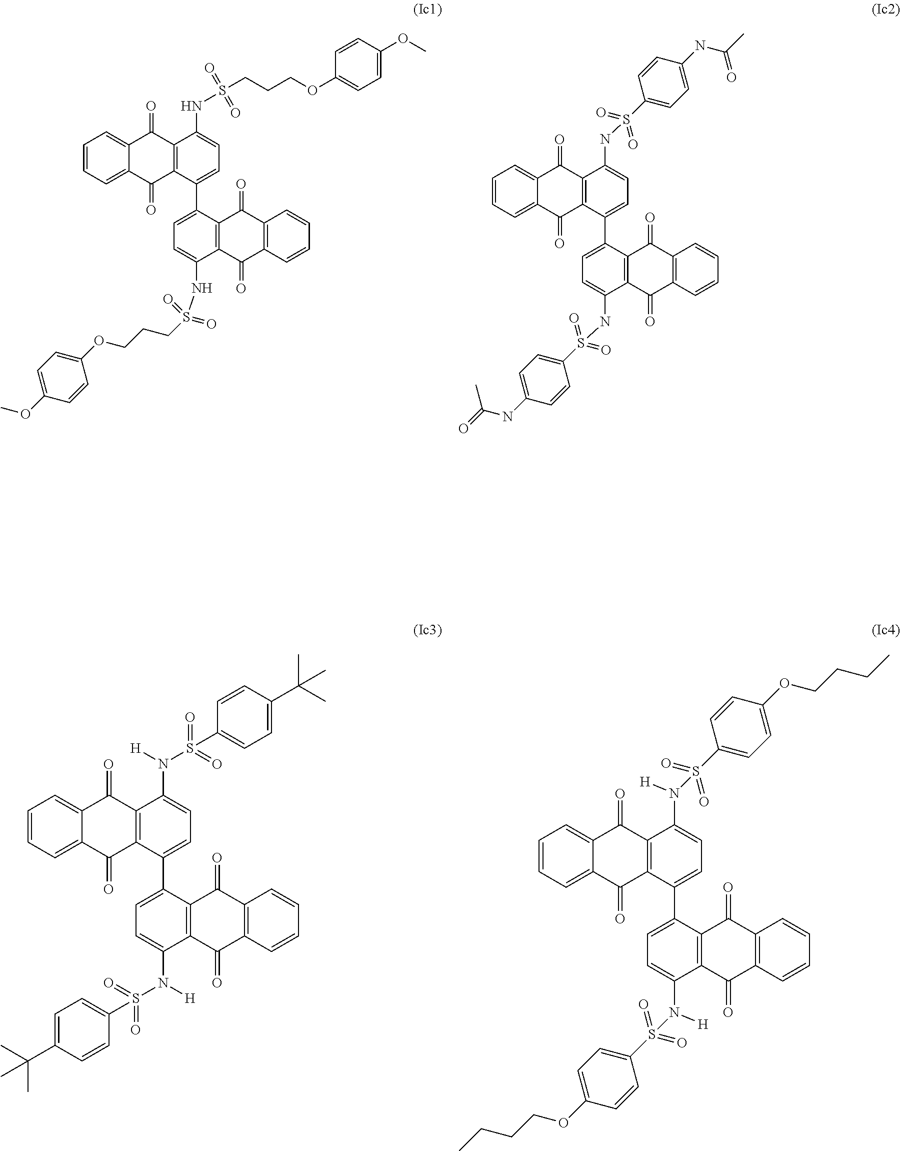

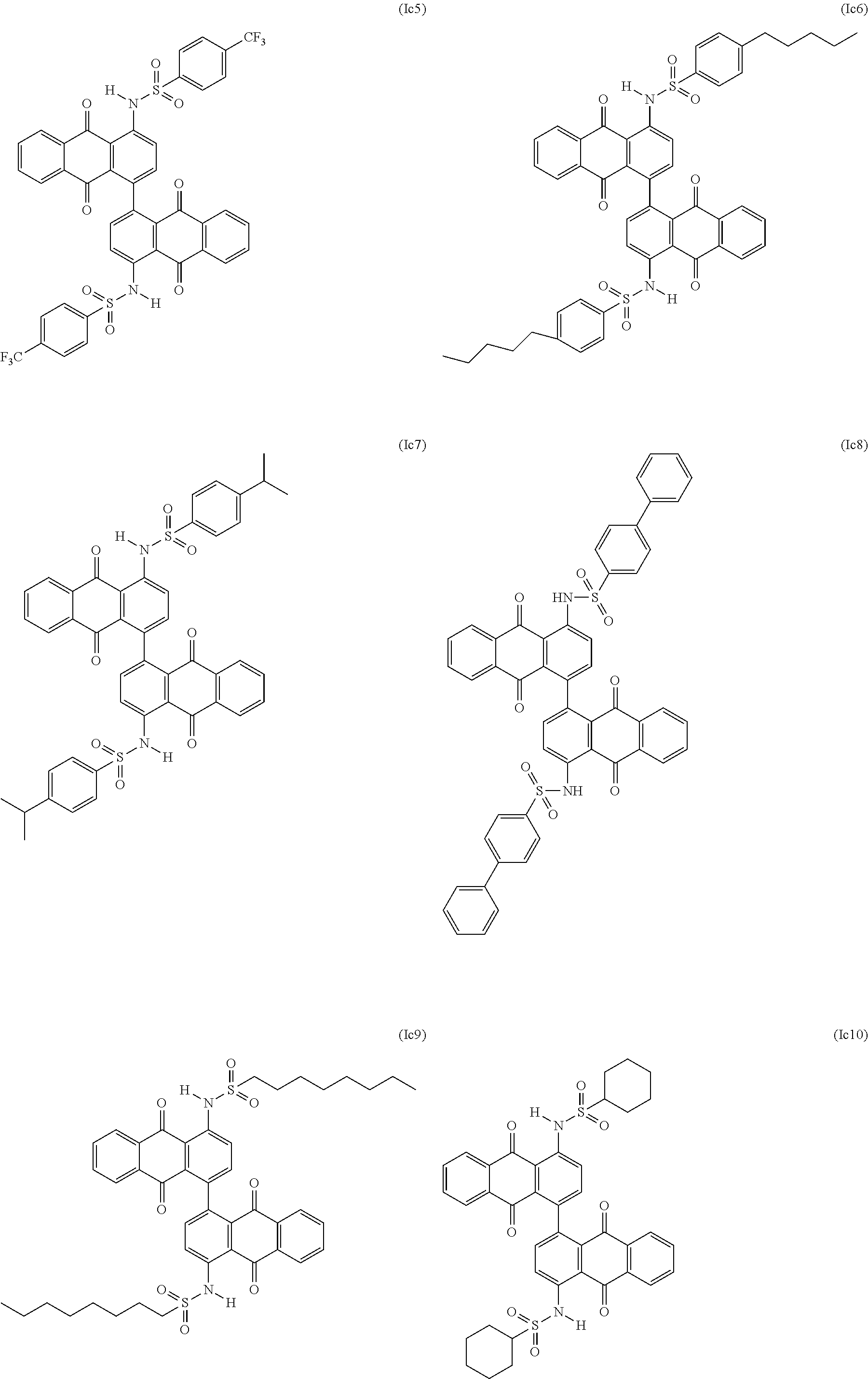

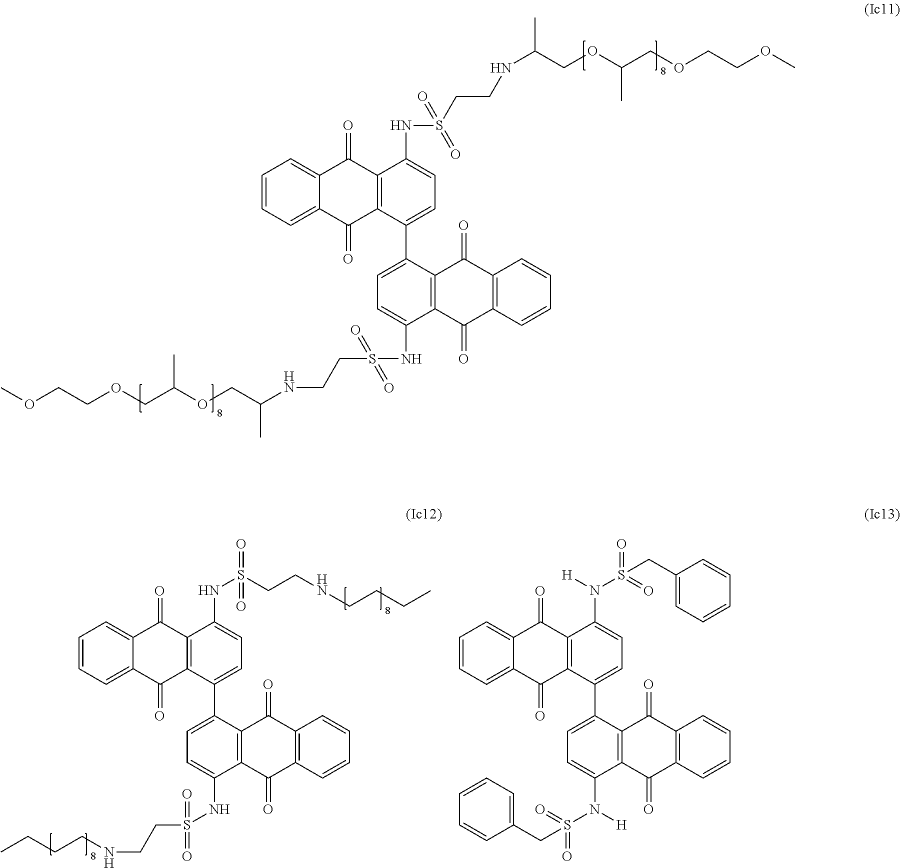

Further particularly preferred dyes of formula (I) according to the present invention conform to formula (Id)

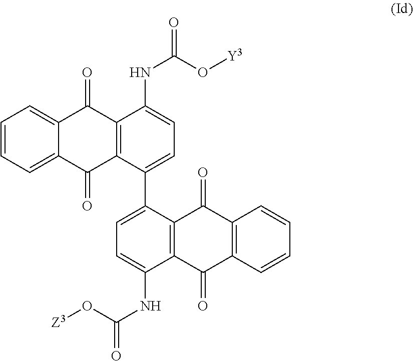

where
Y³ and Z³ each independently represent naphthyl; (C₁-C₃₅)-alkyl substituted by one or more of the G¹⁸ substituents; or (C₂-C₃₅)-alkyl interrupted by one or more oxygen or sulfur atoms and substituted by one or more of the G¹⁸ substituents;
G¹⁸ represents cyclo-(C₃-C₈)-alkyl; aryl; halogen; cyano; (C₁-C₃₅)-alkoxy; aryloxy; (C₂-C₃₅)-acyl; arylcarbonyl, (C₂-C₃₅)-acylamino; (C₁-C₃₅)-alkylsulfonylamino; arylsulfonylamino; arylcarbonylamino; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; aminosulfonylamino; (C₁-C₃₅)-alkylthio; arylthio; (C₁-C₃₅)-alkylsulfonyl, arylsulfonyl or a group of formula (4) defined above, preferably of group (4a) defined above.

In particularly preferred dyes of formula (Id), Y³ and Z³ each independently represent naphthyl or (C₁-C₆)-alkyl substituted by (C₁₀-C₂₀)-thioalkyl, (C₁₀-C₂₀)-alkylamino, chlorophenyl, phenyl-(C₁-C₄)-alkoxy, fluorine, one, two or three chlorines or by a group of formula (4a)

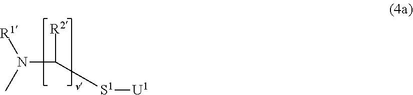

where
R^{1′} represents hydrogen;
R^{2′} represents hydrogen or methyl;
v′ represents 1;
S¹ represents a group of formula (5a):

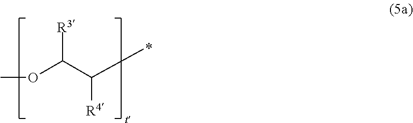

where
* indicates the bond to the U¹ group;
t′ represents a number from 1 to 20;
R^{3′} and R^{4′} each independently represent hydrogen or methyl; where R^{3′} and R^{4′} each have identical or different meanings within a molecule of formula (Id); and where when R^{3′} and R^{4′} have different meanings within a molecule of formula (Id), these different meanings are randomly distributed or regions of respectively identical meanings follow each other; and
U¹ represents (C₁-C₁₂)-alkoxy.

Examples of dyes of formula (Id) are the dyes of formulae (Id1) to (Id15)

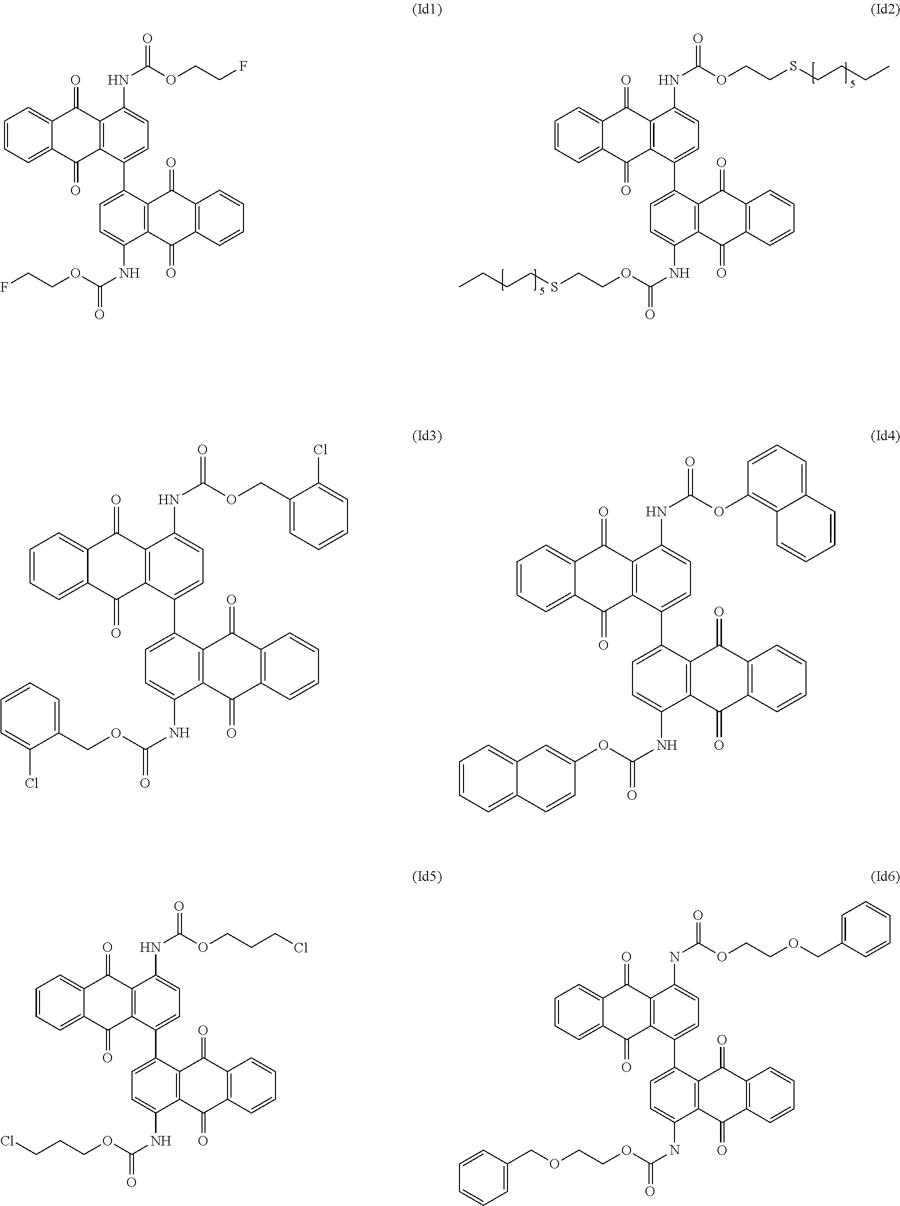

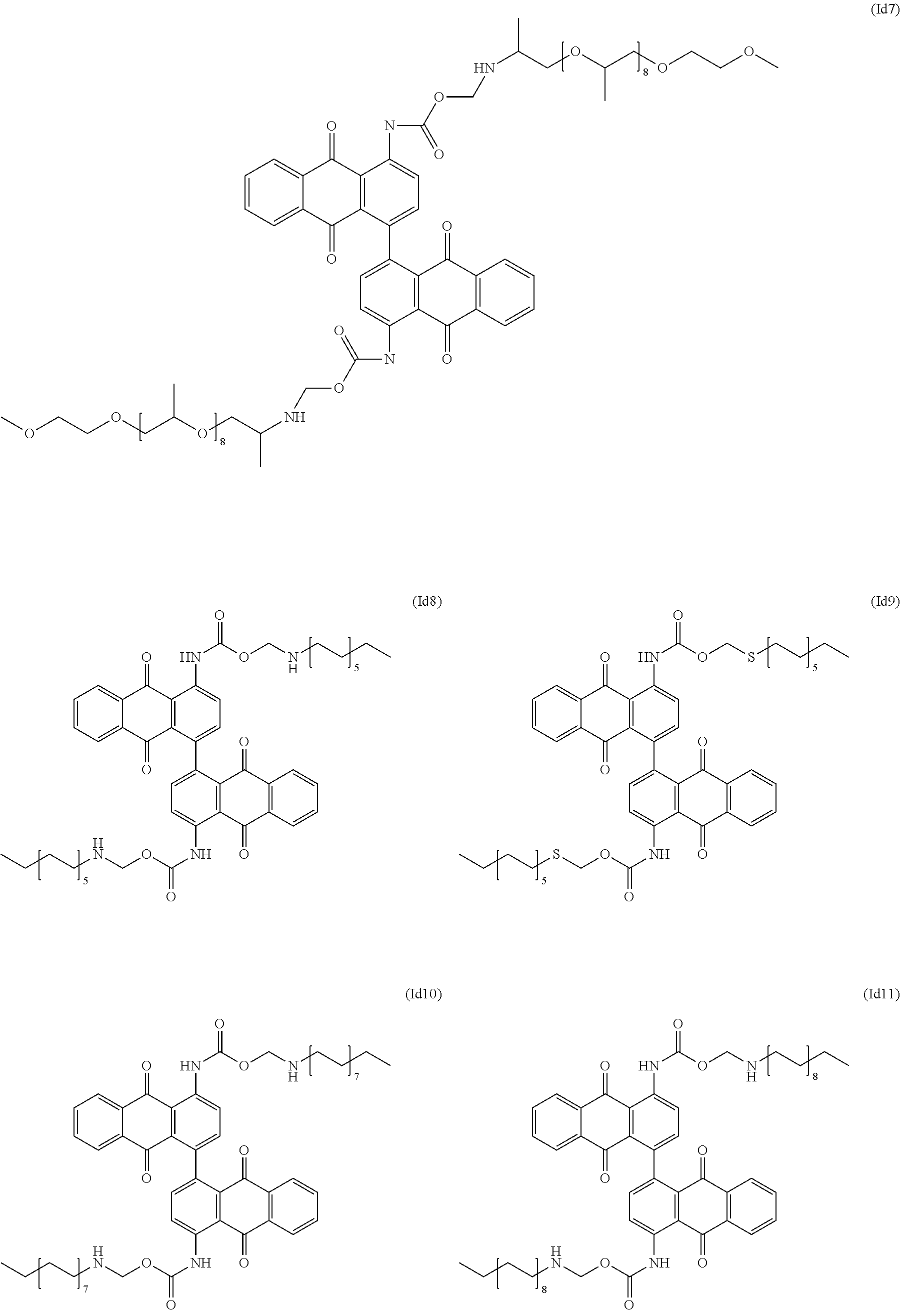

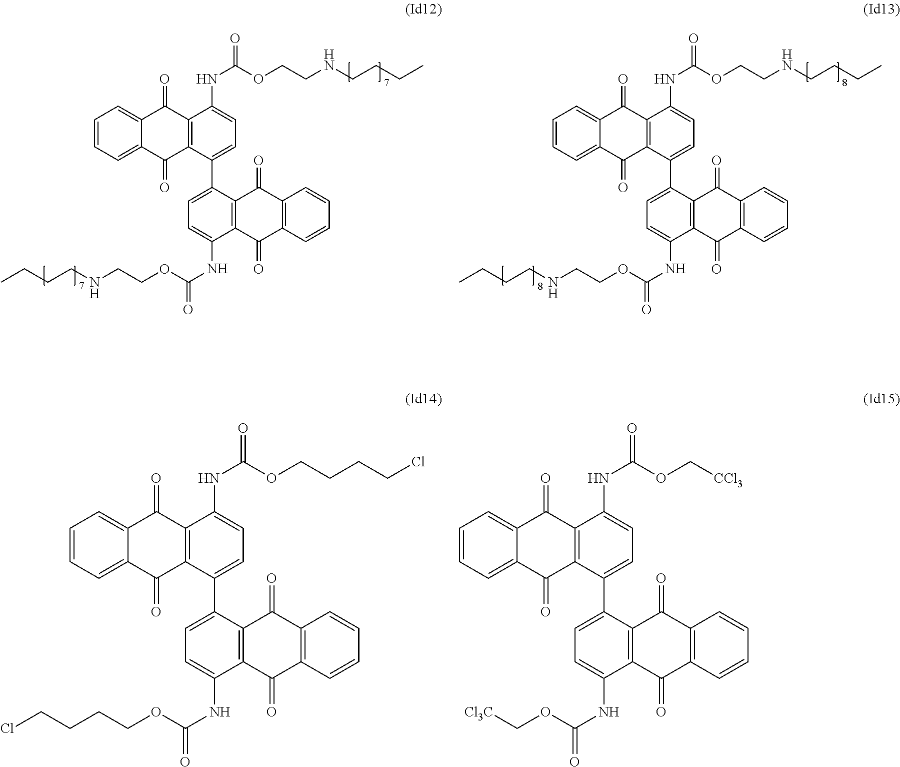

The dyes of formula (I) are obtainable by reacting the compound of formula (II)

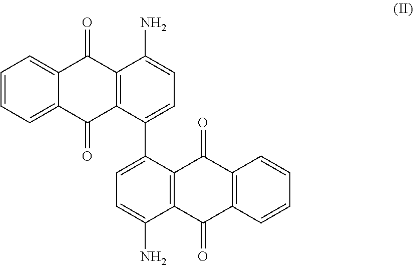

with a compound of formulae (III) and a compound of formula (IV)

K—X—Y (III)

K-T-Z (IV)

where X, Y, T and Z are each as defined above and K represents chlorine or bromine.

This reaction is particularly carried out at a temperature of 50-200° C., more preferably of 50-180° C., in the absence or presence of a base such as pyridine, piperidine, sodium acetate, potassium carbonate or aluminum chloride and preferably in the absence of moisture and with a nitrogen stream. The reaction medium used is preferably an inert solvent or a mixture of inert solvents. Useful solvents include chlorinated solvents such as chlorobenzene or 1,2-dichlorobenzene, alcohols such as for example n-pentanol, 1-methoxy-2-propanol, 2-ethylhexanol, 2-methyl-1-butanol, isoamyl alcohol, benzyl alcohol, cyclohexanol, glycols and derivatives thereof such as for example ethylene glycol diethyl ether, ethylene glycol monomethyl ether, ethylene glycol monoethyl ether, ethylene glycol monoisopropyl ether, ethylene glycol monobutyl ether, diethylene glycol dimethyl ether, diethylene glycol diethyl ether, diethylene glycol monomethyl ether, ethylene glycol, diethylene glycol monoethyl ether, dipropylene glycol, ethers such as for example dibutyl ether, diisobutyl ether, diisoamyl ether, di-n-amyl ether, or further polar or apolar inert solvents such as for example ethylbenzene, anisole, N,N-dimethylformamide, N,N-dimethylacetamide, sulfolane, N-methylpyrrolidone, toluene, 1,2-xylene, 1,3-xylene, 1,4-xylene or mixtures thereof.

Such reactions are known for example from DE 3514077 and EP 0 710 706 A2.

In the case of symmetrically substituted dyes of formula (I), the compounds of formulae (III) and (IV) can be reacted with the compound of formula (II) as a mixture. In the case of asymmetrically substituted dyes of formula (I), the condensation reactions can be carried out in succession with or without intervening isolation of the intermediates formed.

Certain dyes of formula (I), for example those of formula (Ib), are preferably prepared by following an alternative, two-stage process. In this alternative, two-stage process, the first step comprises reacting the compound of formula (II) with the compounds of formulae (III) and (IV) as indicated above, although the group Y or Z contains a functional group, for example a chlorine atom. In a subsequent step of the synthesis, the dye obtained can then be reacted with a nucleophile to form further dyes of formula (I). Suitable nucleophiles are for example amine and mercaptan derivatives. Such derivatives are known and commercially available.

Preferred amine derivatives are in particular the compounds sold by Huntsman, The Woodlands, Tex., USA under the brand name of Jeffamine®. Examples are Jeffamine M-600, Jeffamine M-2005, Jeffamine M-2070, Jeffamine M-1000, Jeffamine D-230, Jeffamine D-400, Jeffamine D-2000, Jeffamine D-4000, Jeffamine HK-511, Jeffamine ED-600, Jeffamine ED-900, Jeffamine ED-2003, Jeffamine ED-2001, Jeffamine EDR-148, Jeffamine EDR-176, Jeffamine T-403, Jeffamine M-3000, Jeffamine T-5000, Jeffamine XTJ-435 and Jeffamine XTJ-436. When these compounds are used, the resulting dyes of formula (I) form statistical polymeric mixtures.

The compound of formula (II) is known as Colour Index dye C.I. Pigment Red 177 and commercially available.

Similarly, the compounds of formulae (III) and (IV) are commercially available or are obtainable by following known methods.

After synthesis, the dyes of formula (I) can be isolated by filtration, extraction or evaporation and, if necessary, drying. However, they can also be used without further workup.

The dyes of formula (I) according to the present invention can be used directly for polymer coloration, or they are subjected to a finishing (conditioning) operation to convert them into a saleable dye preparation.

Finishing can be effected proceeding from a single dye of formula (I) or from a mixture of two or more dyes of formula (I) or mixtures of one or more of the dyes of formula (I) and dyes of other dye classes, for example pigments or solvent dyes, if appropriate with the assistance of auxiliaries, for example surface modifiers and dispersants, by dispersing, suspending or dissolving in a liquid or solid carrier material and also if appropriate standardizing to a desired color strength and a desired hue and if appropriate drying the preparation thus obtained.

Preparations comprising dyes of formula (I) may further comprise auxiliaries for modifying viscosity/flowability.

Useful auxiliaries of this kind are described for example in U.S. Pat. No. 6,605,126. Preferred examples are ethylene glycols, propylene glycols, polyether polyols, polyester polyols, lactones and carbonic esters.

The present invention accordingly also provides dye preparations comprising one or more dyes of formula (I) and also one or more auxiliaries for modifying viscosity/flowability.

These dye preparations preferably contain one or more dyes of formula (I) in amounts of 5% to 100% by weight and one or more auxiliaries for modifying viscosity/flowability in amounts of 0% to 95% by weight, all based on the dye preparation.

The present invention further provides for the use of the dyes of formula (I) for coloring a polymer.

A possible procedure here is for the dyes of formula (I) to be admixed to the polymer. In addition, dyes of formula (I) according to the present invention can also be used in the form of masterbatches. Masterbatches are dye concentrates consisting of carrier materials and colorants, the colorants being present in higher concentration than in the final use and the carrier materials being constituted such that they have compatibility with the materials to be colored. The carrier materials used can be polymers, for example polyolefins, polyurethane, polyvinyl chloride, polyesters, polyamides, polycarbonates or polystyrene. Preferred polymers are polyolefins, for example polyethylene or polypropylene and copolymers with polyolefins. Useful carrier materials further include paraffin oils and polyglycols. The dye masterbatches are characterized in particular in that they contain one or more dyes of formula (I) according to the present invention in amounts of 5% to 60% by weight and one or more carrier materials in amounts of 40% to 95% by weight.

The dyes of formula (I) have advantages in bleed/migration fastness in polyolefin mass coloration in particular, compared with commercially available solvent dyes. These advantages are particularly noticeable in the coloration of polypropylene, polypropylene copolymers and polypropylene blends. To achieve good bleed fastnesses for the colored polymer, it is preferable to use compounds of formula (I) that have sufficiently high molar mass.

The examples hereinbelow serve to elucidate the invention without restricting the invention to these examples. Parts and percentages are by weight, unless otherwise stated. Parts by weight relate to parts by volume as the kilogram relates to the liter.

### EXAMPLE 1

a) A mixture of 7.12 parts of the compound of formula (II), 75 parts of chlorobenzene and 8.73 parts of 3-cyclohexylpropionyl chloride (from Acros) is stirred under reflux at the boiling temperature of the mixture for 3 hours, cooled down and admixed with methanol. The isolated precipitate is stirred out with dilute aqueous sodium hydroxide solution, filtered off, washed neutral with water and dried to leave the dye of formula (Ia7).

b) 1 g of the dye obtained as per a) is comminuted in a mortar and added to altogether 2 kg of polypropylene pellet (Moplen RP340R from Basell). This mixture is mulled on a roller mill until homogeneous and then extruded in a twin-screw extruder (ZSE 18HP-D40 from Leistritz) and pelletized. The pellet obtained can be processed in an injection-molding machine (420 C 1000-100 from Arburg) to form transparent yellow sample plaques. The dye has very good bleed fastness as per prEN14469-4, a high color stability to heat as per EN12877-2 and high lightfastness as per EN ISO 105-B01.

### EXAMPLE 2

a) A mixture of 14.24 parts of compound of formula (II), 125 parts of 1,2-dichlorobenzene and 14.36 parts of 3-cyclohexanecarbonyl chloride (from Aldrich) is stirred at 180° C. for 1 hour, cooled down and admixed with methanol. The isolated precipitate is stirred out with dilute aqueous sodium hydroxide solution, filtered off, washed neutral with water and dried to leave the dye of formula (Ia24).

b) 0.8 g of the dye obtained as per a) is comminuted in a mortar and added to altogether 2 kg of polypropylene pellet (Moplen RP340R from Basell). This mixture is mulled on a roller mill until homogeneous and then extruded in a twin-screw extruder (ZSE 18HP-D40 from Leistritz) and pelletized. The pellet obtained can be processed in an injection-molding machine (420 C 1000-100 from Arburg) to form transparent yellow sample plaques. The dye has very good bleed fastness as per prEN14469-4, a high color stability to heat as per EN12877-2 and high lightfastness as per EN ISO 105-B01.

### EXAMPLE 3

A mixture of 28.48 parts of compound of formula (II), 210 parts of chlorobenzene and 18.2 parts of chloroacetyl chloride (from Riedel-de Haën) is stirred at 100° C. for 4 hours, cooled down and filtered. The isolated precipitate is stirred out with dilute aqueous sodium hydroxide solution, filtered off, washed neutral with water and dried to leave the dye of formula (Ia39).

### EXAMPLE 4

A mixture of 10 parts of the dye of formula (Ia39) as per Example 3, 50 parts of sulfolane, 14.20 parts of 1-dodecanethiol (from Fluka) and 9.4 parts of potassium carbonate is stirred at 125° C. for 5 hours. After cooling, the reaction mixture is admixed with aqueous methanol and the isolated precipitate is washed neutral with water and dried to leave the dye of formula (Ia4).

### EXAMPLE 5

A mixture of 7.9 parts of the dye of formula (Ia39) as per Example 3 and 50 parts of Jeffamine® M-600 is stirred at 150° C. for 4 hours. After cooling, the reaction mixture is admixed with aqueous methanol and the isolated precipitate is washed acid and then neutral and dried to leave the dye of formula (Ib1).

### EXAMPLE 6

a) A mixture of 3.6 parts of compound of formula (II), 50 parts of 1,2-dichlorobenzene and 6.1 parts of biphenyl-4-sulfonyl chloride (from Aldrich) is stirred at 185° C. for 6 hours, cooled down and admixed with aqueous methanol. The isolated precipitate is purified with methanol and dried to leave the dye of formula (Ic8).

b) 1.16 g of the dye obtained as per a) is comminuted in a mortar and added to altogether 2 kg of polypropylene pellet (Moplen RP340R from Basell). This mixture is mulled on a roller mill until homogeneous and then extruded in a twin-screw extruder (ZSE 18HP-D40 from Leistritz) and pelletized. The pellet obtained can be processed in an injection-molding machine (420 C 1000-100 from Arburg) to form transparent orange sample plaques. The dye has very good bleed fastness as per prEN14469-4, a high color stability to heat as per EN12877-2 and high lightfastness as per EN ISO 105-B01.

### EXAMPLE 7

A mixture of 3.3 parts of compound of formula (II), 40 parts of 1,2-dichlorobenzene and 10.0 parts of 2-benzyloxyethyl chloroformate (from Aldrich) is stirred at 185° C. for 10 hours. After cooling, the reaction mixture is admixed with aqueous methanol and the isolated precipitate is purified with methanol and dried to leave the dye of formula (Id6).

### EXAMPLE 8

a) A mixture of 7.12 parts of compound of formula (II), 75 parts of chlorobenzene and 8.38 parts of 3-cyclopentylpropionyl chloride (from Aldrich) is stirred 180° C. for 2 hours, cooled down and filtered. The isolated precipitate is purified with warm methanol and dried to leave the dye of formula (Ia8).

b) 1 g of the dye obtained as per a) is comminuted in a mortar and added to altogether 2 kg of polypropylene pellet (Moplen RP340R from Basell). This mixture is mulled on a roller mill until homogeneous and then extruded in a twin-screw extruder (ZSE 18HP-D40 from Leistritz) and pelletized. The pellet obtained can be processed in an injection-molding machine (420 C 1000-100 from Arburg) to form transparent yellow sample plaques. The dye has very good bleed fastness as per prEN14469-4, a high color stability to heat as per EN12877-2 and high lightfastness as per EN ISO 105-B01.

1.-8. (canceled)

9. A dye of formula (I) 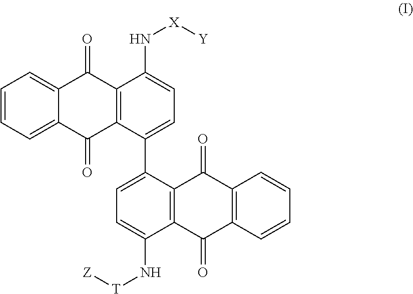
where
X and T each independently represent a group of formula (1) to (3) 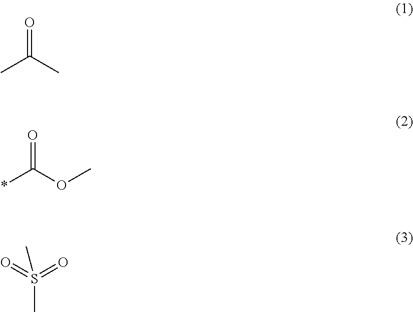
where
* indicates the bond to the —NH— group;
Y and Z each independently have one of the meanings G¹ or G²;
G¹ represents Ar; cyclo-(C₃-C₈)-alkyl; (C₁-C₃₅)-alkyl; (C₂-C₃₅)-alkyl interrupted by one or more hetero atoms; (C₁-C₃₅)-alkyl substituted by one or more of the substituents G³ to G⁶; or (C₂-C₃₅)-alkyl interrupted by one or more hetero atoms and substituted by one or more of the substituents G³ to G⁶;
G³ represents trifluoromethyl; cyclo-(C₃-C₈)-alkyl; Ar; heteroaryl; heterocycloalkyl; halogen; cyano; nitro; hydroxyl; (C₁-C₃₅)-alkoxy; Ar-oxy; (C₂-C₃₅)-acyl; Ar-carbonyl, (C₂-C₃₅)-acyloxy; Ar-carbonyloxy; (C₂-C₃₅)-acylamino; (C₁-C₃₅)-alkylsulfonylamino; Ar-sulfonylamino; Ar-carbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoAr-carbamoyl; N,N-diAr-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; Ar-oxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoAr-amino; diAr-amino; monocyclo-(C₃-C₈)-alkylmonoAr-amino; mono-(C₁-C₃₅)-alkylmonoAr-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoAr-sulfamoyl; N,N-diAr-sulfamoyl; N-monocyclo-(C₃-C₈)-alkyl-N-monoAr-sulfamoyl; N-mono-(C₁-C₃₅)-alkyl-N-monoAr-sulfamoyl; aminosulfonylamino; (C₁-C₃₅)-alkylthio; Arthio; (C₁-C₃₅)-alkylsulfonyl or Ar-sulfonyl;
G⁴ represents (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; N,N-Di-(C₂-C₃₅)-alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoarylamino; N-mono-(C₂-C₃₅)-alkyl-sulfamoyl; N,N-di-(C₂-C₃₅)-alkyl-sulfamoyl; N-mono-(C₂-C₃₅)-alkyl-N-monoAr-sulfamoyl; (C₂-C₃₅)-alkylthio or (C₂-C₃₅)-alkylsulfonyl where the alkyl radical is interrupted by one or more hetero atoms;
G⁵ represents cyclo-(C₃-C₈)-alkyl; heterocycloalkyl; (C₁-C₃₅)-alkoxy; (C₂-C₃₅)-acyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoAr-sulfamoyl; N-mono-(C₁-C₃₅)-alkyl-N-monoAr-sulfamoyl; (C₁-C₃₅)-alkylthio or (C₁-C₃₅)-alkylsulfonyl where the alkyl radical is substituted by a G⁷ radical;
G⁶ represents G⁴ where the alkyl radical is substituted by a G⁷ radical;
G⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoarylamino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkylsulfamoyl; N-monoarylsulfamoyl; N,N-diarylsulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl; (C₂-C₃₅)-alkylsulfonyl whose alkyl group is substituted by one or more heteroatoms; or represents arylsulfonyl;
G² represents (C₁-C₃₅)-alkyl or (C₂-C₃₅)-alkyl interrupted by one or more heteroatoms, where the alkyl group is in each case substituted by a group of formula (4) 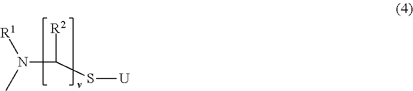
where
R¹ represents hydrogen; aryl; (C₁-C₃₅)-alkyl; (C₂-C₃₅)-alkyl interrupted by one or more hetero atoms; (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl; monohydroxy-(C₁-C₃₅)-alkyl; polyhydroxy-(C₂-C₃₅)-alkyl; (C₁-C₃₅)-alkoxyalkyl or aryloxy-(C₁-C₃₅)-alkyl;
R² represents hydrogen, (C₁-C₃₅)-alkyl, singly or multiply oxygen-interrupted (C₂-C₃₅)-alkyl, aryl, aryl-(C₁-C₃₅)-alkyl, (C₁-C₃₅)-alkyl-aryl, aryloxy, (C₁-C₃₅)-alkoxy, monohydroxy-(C₁-C₃₅)-alkyl or polyhydroxy-(C₂-C₃₅)-alkyl; and has identical or different meanings within a molecule of formula (i);
v represents a number from 1 to 35;
S represents a group of formula (5) 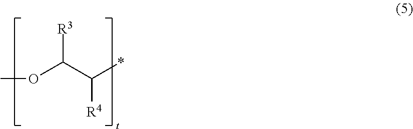
where
* indicates the bond to the U group;
t represents a rational number from 0 to 200 and has identical or different meanings within a molecule of formula (I); and
R³ and R⁴ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)-alkyl;
where R³ and R⁴ each have identical or different meanings within a molecule of formula (I); and where when R³ and R⁴ have different meanings within a molecule of formula (I) these different meanings are randomly distributed or regions of respectively identical meanings follow each other;
U represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
where, in the groups G¹ to G⁶, Ar represents a group of formula (6) or (7) 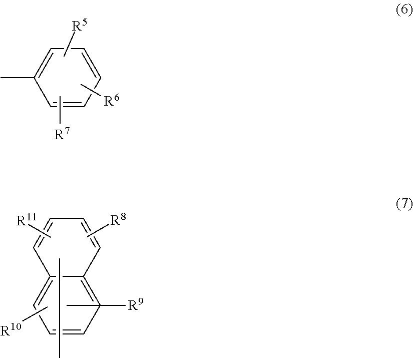
where
R⁵ to R¹¹ each independently have one of the meanings G⁸ to G¹¹ or represent a group of formula (8) 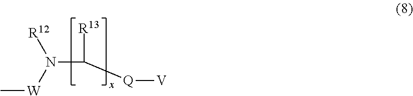
where
W represents a group of formula (1), (3) or (9) 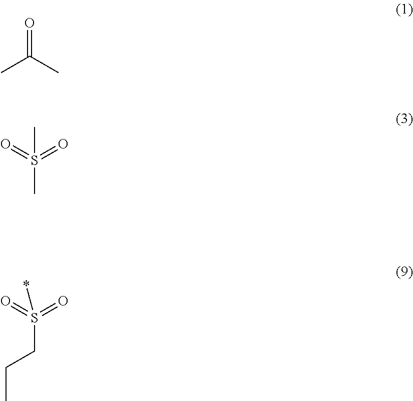
and * indicates the bond to the —NR¹² group;
R¹² represents hydrogen, aryl, (C₁-C₃₅)-alkyl, (C₂-C₃₅)-alkyl interrupted by one or more hetero atoms, (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl monohydroxy-(C₁-C₃₅)-alkyl, polyhydroxy-(C₂-C₃₅)-alkyl, (C₁-C₃₅)-alkoxyalkyl or aryloxy-(C₁-C₃₅)-alkyl;
R¹³ represents hydrogen, (C₁-C₁₅)-alkyl, singly or multiply oxygen-interrupted (C₂-C₁₅)-alkyl, aryl, aryl-(C₁-C₁₅)-alkyl, (C₁-C₁₅)-alkyl-aryl, aryloxy, (C₁-C₅)-alkoxy, monohydroxy-(C₁-C₁₅)-alkyl or polyhydroxy-(C₂-C₁₅)-alkyl and can have identical or different meanings within a molecule of formula (I);
x represents a number from 1 to 35;
V represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
Q represents a group of formula (10) 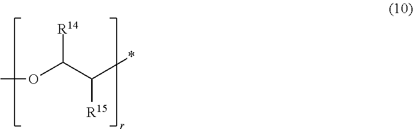
where
* indicates the bond to the V group;
R¹⁴ and R¹⁵ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)alkyl and have identical or different meanings within a molecule of formula (1) and where when R¹⁴ and R¹⁵ have different meanings within a molecule of formula (I) these different meanings are randomly distributed or regions of respectively identical meanings follow each other;
r represents a rational number from 0 to 200 and has identical or different meanings within a molecule of formula (I);
G⁸ represents hydrogen, (C₁-C₃₅)-alkyl; trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl;
G⁹ represents (C₂-C₃₅)-alkyl; (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoaryl-amino; N-mono-(C₂-C₃₅)-alkyl-sulfamoyl; N,N-di-(C₂-C₃₅)-alkyl-sulfamoyl; N-mono-(C₂-C₃₅)-alkyl-N-monoarylsulfamoyl; (C₂-C₃₅)-alkylthio or
(C₂-C₃₅)-alkylsulfonyl where the alkyl radical is interrupted by one or more hetero atoms or one or more hetero atom groups;
G¹⁰ represents (C₁-C₃₅)-alkyl; cyclo-(C₃-C₈)-alkyl; heterocycloalkyl; (C₁-C₃₅)-alkoxy; (C₂-C₃₅)-acyl; cyclo-(C₃-C₈)-alkylcarbonyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino;
N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoarylsulfamoyl; N-mono-(C₁-C₃₅)-alkyl-N-monoarylsulfamoyl; (C₁-C₃₅)-alkylthio or (C₁-C₃₅)-alkylsulfonyl where the alkyl radical is substituted by one or more G⁷ substituents;
G¹¹ represents G⁹ where the alkyl radical is substituted by one or more G⁷ substituents;
where, in the groups G⁷ to G¹¹, aryl represents a group of formula (11) or (12) 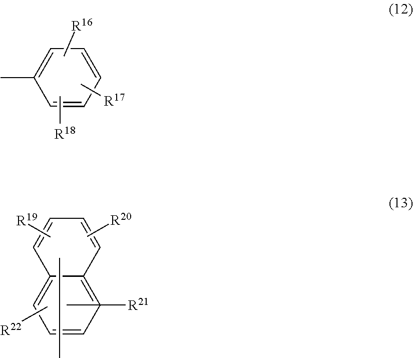
where
R¹⁶ to R²² each independently represent the G¹² group; and
G¹² represents hydrogen; (C₁-C₁₈)-alkyl; monohydroxy-(C₁-C₁₈)-alkyl; polyhydroxy-(C₂-C₁₈)-alkyl; (C₁-C₁₈)-alkyl interrupted by one or more oxygen atoms; trifluoromethyl; cyclo-(C₃-C₈)-alkyl; heteroaryl; heterocycloalkyl; halogen; cyano; nitro; hydroxyl; (C₁-C₁₈)-alkoxy; (C₂-C₁₈)-acyl; cyclo-(C₃-C₈)-alkylcarbonyl, (C₂-C₁₈)-acyloxy; (C₂-C₁₈)-acylamino; (C₁-C₁₈)-alkylsulfonylamino; carbamoyl; N-monocyclo-(C₃-C₈)-alkyl-carbamoyl; N-mono-(C₁-C₁₈)-alkyl-carbamoyl; N,N-dicyclo-(C₃-C₈)-alkyl-carbamoyl; N,N-di-(C₁-C₁₈)-alkyl-carbamoyl; (C₁-C₁₈)-alkoxycarbonyl; amino; monocyclo-(C₃-C₈)-alkyl-amino; mono-(C₁-C₁₈)-alkyl-amino; di(cyclo)-(C₃-C₈)-alkyl-amino; di-(C₁-C₁₈)-alkyl-amino; aminothiocarbonylamino; aminocarbonylamino; sulfamoyl; N-monocyclo-(C₃-C₈)-alkyl-sulfamoyl; N-mono-(C₁-C₁₈)-alkyl-sulfamoyl; N,N-dicyclo-(C₃-C₈)-alkyl-sulfamoyl; N,N-di-(C₁-C₁₈)-alkyl-sulfamoyl; aminosulfonylamino; (C₁-C₁₈)-alkylthio or (C₁-C₁₈)-alkylsulfonyl;
where
when X and T both represent a group of formula (1),
Y and Z do not both represent (C₁-C₃₅)-alkyl; a group of formula (6) where R⁵, R⁶ and R⁷ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino, (C₁-C₃₅)-alkylthio, (C₂-C₃₅)-acyl, benzoylamino or benzenesulfonylamino; or a methyl or ethyl group substituted by a group of formula (7) where R⁴, R⁵ and R⁶ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino or (C₁-C₃₅)-alkylthio;
and it is not the case that one of Y and Z represents (C₁-C₃₅)-alkyl and the other represents hydrogen; and
when X and T both represent a group of formula (2),
Y and Z do not both represent (C₁-C₃₅)-alkyl; (C₁-C₃₅)-alkyl substituted by halogen, (C₁-C₃₅)-alkylsulfonyl, substituted or unsubstituted benzenesulfonyl, or a group of formula (6) where R⁵, R⁶ and R⁷ independently represent hydrogen, halogen, (C₁-C₃₅)-alkyl or (C₁-C₃₅)-alkoxy; a group of formula (6) where R⁵, R⁶ and R⁷ each independently represent hydrogen, halogen, nitro, cyano, (C₁-C₃₅)-alkyl, (C₁-C₃₅)-alkoxy or aryl; or substituted or unsubstituted benzoyl; and
when X and T both represent a group of formula (3),
Y and Z do not both represent a group of formula (6) where R⁵, R⁶ and R⁷ each independently represent hydrogen, halogen, nitro, (C₁-C₃₅)-alkyl, (C₁-C₃₅)-alkoxy; (C₂-C₃₅)-acyl, benzoylamino or benzenesulfonylamino.

10. The dye as claimed in claim 9, conforming to formula (Ia) 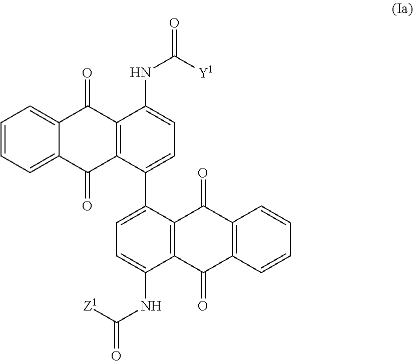
where
Y¹ and Z¹ each independently represent Ar¹; cyclo-(C₃-C₈)-alkyl; (C₁-C₃₅)-alkyl; (C₂-C₃₅)-alkyl interrupted by one or more oxygen or sulfur atoms; (C₁-C₃₅)-alkyl substituted by one or more G¹³ to G¹⁶ substituents; (C₂-C₃₅)-alkyl interrupted by one or more oxygen or sulfur atoms and substituted by one or more G¹³ to G¹⁶ substituents;
G¹³ represents cyclo-(C₅-C₆)-alkyl; aryl; heterocycloalkyl having 5 or 6 ring members; halogen; cyano; hydroxyl; (C₁-C₁₈)-alkoxy; aryloxy; (C₂-C₁₈)-acyl, arylcarbonyl; (C₂-C₃₅)-acylamino; (C₁-C₃₅)-alkylsulfonylamino; arylsulfonylamino; arylcarbonylamino; amino; monocyclo-(C₃-C₈)-alkyl-amino mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; aminosulfonylamino; (C₁-C₃₅)-alkylthio; arylthio; (C₁-C₃₅)-alkylsulfonyl or aryl sulfonyl;
G¹⁴ represents (C₂-C₁₈)-alkoxy; (C₂-C₁₈)-acyl, (C₂-C₃₅)-acylamino; (C₂-C₃₅)-alkylsulfonylamino; mono-(C₂-C₃₅)-alkyl-amino; di-(C₂-C₃₅)-alkyl-amino; mono-(C₂-C₃₅)-alkylmonoaryl-amino; (C₂-C₃₅)-alkylthio; or (C₂-C₃₅)-alkylsulfonyl where the alkyl radical is interrupted by one or more heteroatoms;
G¹⁵ represents cyclo-(C₅-C₆)-alkyl; aryl; heterocycloalkyl having 5 or 6 ring members; (C₁-C₁₈)-alkoxy; (C₂-C₁₈)-acyl, (C₂-C₃₅)-acylamino; (C₁-C₃₅)-alkylsulfonylamino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; (C₁-C₃₅)-alkylthio; or (C₁-C₃₅)-alkylsulfonyl where the alkyl radical is substituted by a G¹⁷ substituent;
G¹⁶ represents G¹⁴ where the alkyl radical is substituted by a G¹⁷ radical;
G¹⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl, (C₂-C₃₅)-alkylsulfonyl whose alkyl group is substituted by one or more heteroatoms or represents arylsulfonyl;
Ar¹ represents a group of formula (6a) or (7a) 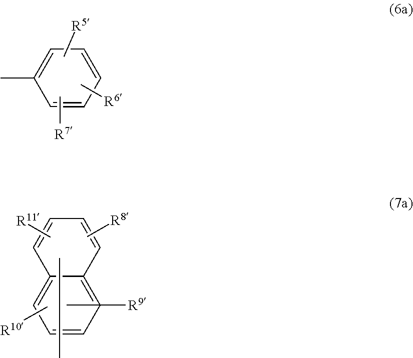
where
R^{5′} to R^{11′} each independently represent hydrogen; (C₁-C₃₅)-alkyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl or a substituent of formula (8a) 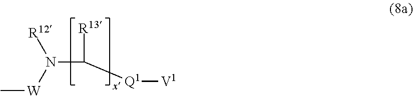
where
W is as defined above;
R^{12′} represents hydrogen, (C₂-C₃₅)-acyl; cyclo(C₃-C₈)-alkylcarbonyl, arylcarbonyl, (C₁-C₃₅)-alkylsulfonyl or arylsulfonyl;
R^{13′} represents hydrogen or (C₁-C₁₅)-alkyl and has identical or different meanings within a molecule of formula (Ia);
x′ represents a number from 1 to 10;
V¹ represents hydrogen, (C₁-C₃₅)-alkyl, aryl, aryloxy, (C₁-C₃₅)-alkoxy or (C₁-C₃₅)-alkyl-aryloxy;
Q represents a group of formula (10a) 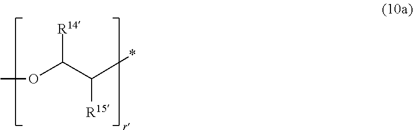
where
* indicates the bond to the V¹ group;
R^{14′} and R^{15′} each independently represent hydrogen or (C₁-C₃₅)-alkyl and have identical or different meanings within a molecule of formula (Ia) and where when R^{14′} and R^{15′} have different meanings within a molecule of formula (Ia) these different meanings are randomly distributed or regions of respectively identical meanings follow each other;
r′ represents a rational number from 0 to 100 and has identical or different meanings within a molecule of formula (Ia); and
aryl is as defined above.

11. The dye as claimed in claim 9, conforming to formula (Ib) 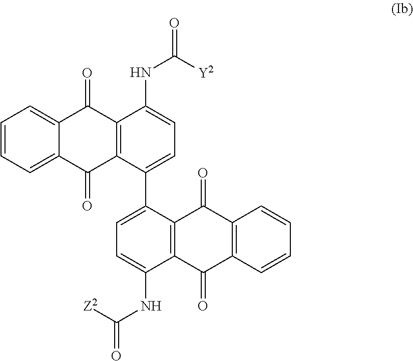
where
Y² and Z² each independently represent (C₁-C₃₅)-alkyl or (C₂-C₃₅)-alkyl interrupted by one or more heteroatoms, where in each case the alkyl group is substituted by a group of formula (4a) 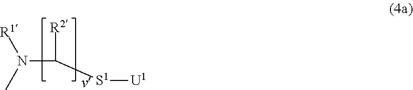
where
R^{1′} represents hydrogen or (C₁-C₃₅)-alkyl;
R^{2′} represents hydrogen or (C₁-C₃₅)-alkyl and has identical or different meanings within a molecule of formula (Ib);
v′ represents a number from 1 to 10.
S¹ represents a group of formula (5a): 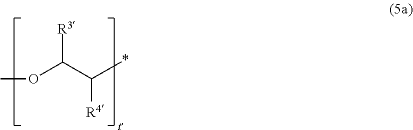
where
* indicates the bond to the U¹ group;
t′ represents a rational number from 0 to 100 and has identical or different meanings within a molecule of formula (Ib);
R^{3′} and R^{4′} each independently represent hydrogen or (C₁-C₃₅)-alkyl; where R^{3′} and R^{4′} each have identical or different meanings within a molecule of formula (Ib); and where when R^{3′} and R^{4′} have different meanings within a molecule of formula (Ib) these different meanings are randomly distributed or regions of respectively identical meanings follow each other; and
U¹ represents hydrogen, (C₁-C₃₅)-alkyl, aryl, aryloxy, (C₁-C₃₅)-alkoxy, or (C₁-C₃₅)-alkyl-aryloxy.

12. The dye as claimed in claim 9, conforming to formula (Ic) 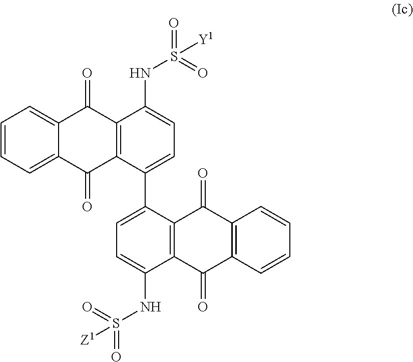
where
Y¹ and Z¹ each independently represent Ar¹; cyclo-(C₃-C₈)-alkyl; (C₁-C₃₅)-alkyl; (C₂-C₃₅)-alkyl interrupted by one or more oxygen or sulfur atoms; (C₁-C₃₅)-alkyl substituted by one or more G¹³ to G¹⁶ substituents; (C₂-C₃₅)-alkyl interrupted by one or more oxygen or sulfur atoms and substituted by one or more G¹³ to G¹⁶ substituents;
G¹³ represents cyclo-(C₅-C₆)-alkyl; aryl; heterocycloalkyl having 5 or 6 ring members; halogen; cyano; hydroxyl; (C₁-C₁₈)-alkoxy; aryloxy; (C₂-C₁₈)-acyl, arylcarbonyl; (C₂-C₃₅)-acylamino; (C₁-C₃₅)-alkylsulfonylamino; arylsulfonylamino; arylcarbonylamino; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; aminosulfonylamino; (C₁-C₃₅)-alkylthio; arylthio; (C₁-C₃₅)-alkylsulfonyl or arylsulfonyl;
G¹⁴ represents (C₂-C₁₈)-alkoxy; (C₂-C₁₈)-acyl, (C₂-C₃₅)-acylamino; (C₂-C₃₅)-alkylsulfonylamino; mono-(C₂-C₃₅)-alkyl-amino; di-(C₂-C₃₅)-alkyl-amino; mono-(C₂-C₃₅)-alkylmonoaryl-amino; (C₂-C₃₅)-alkylthio; or (C₂-C₃₅)-alkylsulfonyl where the alkyl radical is interrupted by one or more heteroatoms;
G¹⁵ represents cyclo-(C₅-C₆)-alkyl; aryl; heterocycloalkyl having 5 or 6 ring members; (C₁-C₁₈)-alkoxy; (C₂-C₁₈)-acyl, (C₂-C₃₅)-acylamino; (C₁-C₃₅)-alkylsulfonylamino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; (C₁-C₃₅)-alkylthio; or (C₁-C₃₅)-alkylsulfonyl where the alkyl radical is substituted by a G¹⁷ substituent;
G¹⁶ represents G¹⁴ where the alkyl radical is substituted by a G¹⁷ radical;
G¹⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl, (C₂-C₃₅)-alkylsulfonyl whose alkyl group is substituted by one or more heteroatoms or represents arylsulfonyl;
Ar¹ represents a group of formula (6a) or (7a) 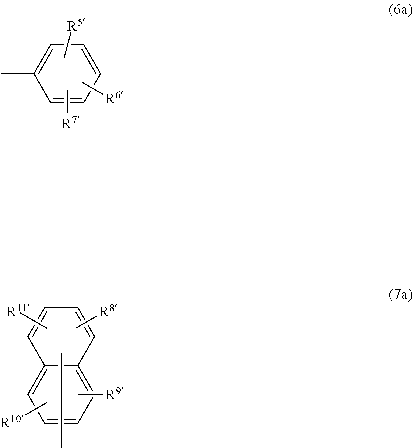
where
R^{5′} to R^{11′} each independently represent hydrogen; (C₁-C₃₅)-alkyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl or a substituent of formula (8a) 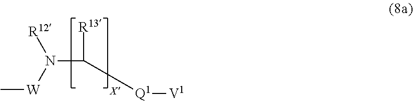
where
W is as defined above;
R^{12′} represents hydrogen, (C₂-C₃₅)-acyl; cyclo(C₃-C₈)-alkylcarbonyl, arylcarbonyl, (C₁-C₃₅)-alkylsulfonyl or arylsulfonyl;
R^{13′} represents hydrogen or (C₁-C₁₅)-alkyl and has identical or different meanings within a molecule of formula (Ia);
x′ represents a number from 1 to 10;
V¹ represents hydrogen, (C₁-C₃₅)-alkyl, aryl, aryloxy, (C₁-C₃₅)-alkoxy or (C₁-C₃₅)-alkyl-aryloxy;
Q¹ represents a group of formula (10a) 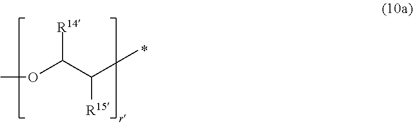
where
* indicates the bond to the V¹ group;
R^{14′} and R^{15′} each independently represent hydrogen or (C₁-C₃₅)-alkyl and have identical or different meanings within a molecule of formula (Ia) and where when R^{14′} and R^{15′} have different meanings within a molecule of formula (Ia) these different meanings are randomly distributed or regions of respectively identical meanings follow each other;
r′ represents a rational number from 0 to 100 and has identical or different meanings within a molecule of formula (Ia); and
aryl is as defined above.

13. The dye as claimed in claim 9, conforming to formula (Id) 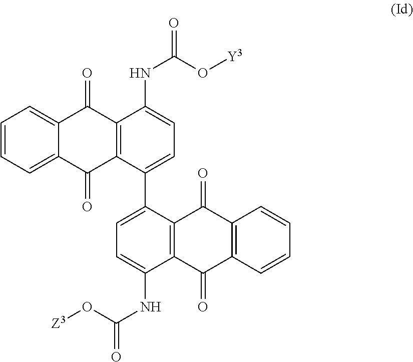
where
Y³ and Z³ each independently represent naphthyl; (C₁-C₃₅)-alkyl substituted by one or more of the G¹⁸ substituents; or (C₂-C₃₅)-alkyl interrupted by one or more oxygen or sulfur atoms and substituted by one or more of the G¹⁸ substituents;
G¹⁸ represents cyclo-(C₃-C₈)-alkyl; aryl; halogen; cyano; (C₁-C₃₅)-alkoxy; aryloxy; (C₂-C₃₅)-acyl; arylcarbonyl, (C₂-C₃₅)-acylamino; (C₁-C₃₅)-alkylsulfonylamino; arylsulfonylamino; arylcarbonylamino; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; aminosulfonylamino; (C₁-C₃₅)-alkylthio; arylthio; (C₁-C₃₅)-alkylsulfonyl, arylsulfonyl or a group of formula (4) defined in claim 9.

14. A process for preparing a dye of formula (I) as claimed in claim 9, which comprises reacting the compound of formula (II) 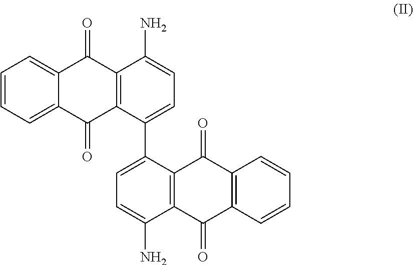
with a compound of formulae (III) and a compound of formula (IV)
K—X—Y (III)
K-T-Z (IV)
where X, Y, T and Z are each as defined in claim 9 and K represents chlorine or bromine.

15. A process for coloring a polymer which comprises utilizing the dye of formula (I) as claimed in claim 9.

16. A masterbatch comprising a compound of formula (I) and a carrier material 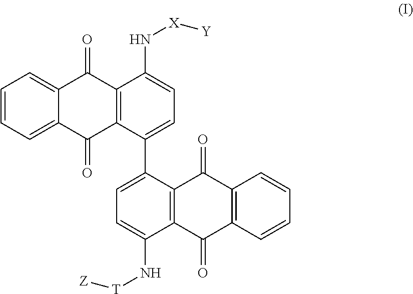
where
X and T each independently represent a group of formula (1) to (3) 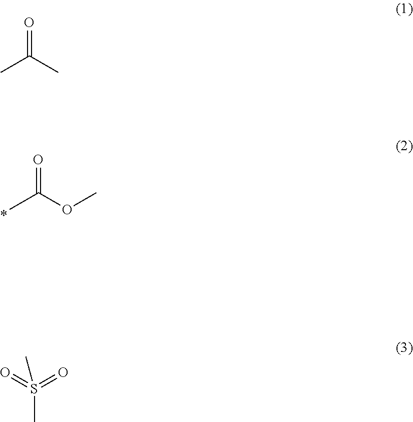
where
* indicates the bond to the —NH— group;
Y and Z each independently have one of the meanings G¹ or G²;
G¹ represents Ar; cyclo-(C₃-C₈)-alkyl; (C₁-C₃₅)-alkyl; (C₂-C₃₅)-alkyl interrupted by one or more hetero atoms; (C₁-C₃₅)-alkyl substituted by one or more of the substituents G³ to G⁶; or (C₂-C₃₅)-alkyl interrupted by one or more hetero atoms and substituted by one or more of the substituents G³ to G⁶;
G³ represents trifluoromethyl; cyclo-(C₃-C₈)-alkyl; Ar; heteroaryl; heterocycloalkyl; halogen; cyano; nitro; hydroxyl; (C₁-C₃₅)-alkoxy; Ar-oxy; (C₂-C₃₅)-acyl; Ar-carbonyl, (C₂-C₃₅)-acyloxy; Ar-carbonyloxy; (C₂-C₃₅)-acylamino; (C₁-C₃₅)-alkylsulfonylamino; Ar-sulfonylamino; Ar-carbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoAr-carbamoyl; N,N-diAr-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; Ar-oxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoAr-amino; diAr-amino; monocyclo-(C₃-C₈)-alkylmonoAr-amino; mono-(C₁-C₃₅)-alkylmonoAr-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoAr-sulfamoyl; N,N-diAr-sulfamoyl; N-monocyclo-(C₃-C₈)-alkyl-N-monoAr-sulfamoyl; N-mono-(C₁-C₃₅)-alkyl-N-monoAr-sulfamoyl; aminosulfonylamino; (C₁-C₃₅)-alkylthio; Arthio; (C₁-C₃₅)-alkylsulfonyl or Ar-sulfonyl;
G⁴ represents (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; N,N-Di-(C₂-C₃₅)-alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoarylamino; N-mono-(C₂-C₃₅)-alkyl-sulfamoyl; N,N-di-(C₂-C₃₅)-alkyl-sulfamoyl; N-mono-(C₂-C₃₅)-alkyl-N-monoAr-sulfamoyl; (C₂-C₃₅)-alkylthio or (C₂-C₃₅)-alkylsulfonyl where the alkyl radical is interrupted by one or more hetero atoms;
G⁵ represents cyclo-(C₃-C₈)-alkyl; heterocycloalkyl; (C₁-C₃₅)-alkoxy; (C₂-C₃₅)-acyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoAr-carbamoyl; N-mono-(C₁-C₃₅)-alkyl-N-monoAr-carbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoAr-sulfamoyl; N-mono-(C₁-C₃₅)-alkyl-N-monoAr-sulfamoyl; (C₁-C₃₅)-alkylthio or (C₁-C₃₅)-alkylsulfonyl where the alkyl radical is substituted by a G⁷ radical;
G⁶ represents G⁴ where the alkyl radical is substituted by a G⁷ radical;
G⁷ represents trifluoromethyl; cyclo-(C₃-C₈)-alkyl; aryl; heteroaryl; heterocycloalkyl; halogen; cyano; nitro; hydroxyl; (C₁-C₃₅)-alkoxy; aryloxy; (C₂-C₃₅)-acyl; arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoarylamino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkylsulfamoyl; N-monoarylsulfamoyl; N,N-diarylsulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl; (C₂-C₃₅)-alkylsulfonyl whose alkyl group is substituted by one or more heteroatoms; or represents arylsulfonyl;
G² represents (C₁-C₃₅)-alkyl or (C₂-C₃₅)-alkyl interrupted by one or more heteroatoms, where the alkyl group is in each case substituted by a group of formula (4) 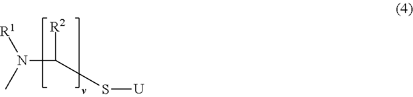
where
R¹ represents hydrogen; aryl; (C₁-C₃₅)-alkyl; (C₂-C₃₅)-alkyl interrupted by one or more hetero atoms; (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl; monohydroxy-(C₁-C₃₅)-alkyl; polyhydroxy-(C₂-C₃₅)-alkyl; (C₁-C₃₅)-alkoxyalkyl or aryloxy-(C₁-C₃₅)-alkyl;
R² represents hydrogen, (C₁-C₃₅)-alkyl, singly or multiply oxygen-interrupted (C₂-C₃₅)-alkyl, aryl, aryl-(C₁-C₃₅)-alkyl, (C₁-C₃₅)-alkyl-aryl, aryloxy, (C₁-C₃₅)-alkoxy, monohydroxy-(C₁-C₃₅)-alkyl or polyhydroxy-(C₂-C₃₅)-alkyl; and has identical or different meanings within a molecule of formula (I);
v represents a number from 1 to 35;
S represents a group of formula (5) 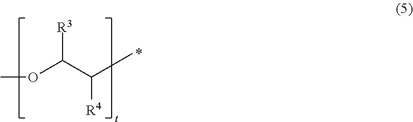
where
* indicates the bond to the U group;
t represents a rational number from 0 to 200 and has identical or different meanings within a molecule of formula (I); and
R³ and R⁴ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)-alkyl;
where R³ and R⁴ each have identical or different meanings within a molecule of formula (I); and where when R³ and R⁴ have different meanings within a molecule of formula (I) these different meanings are randomly distributed or regions of respectively identical meanings follow each other;
U represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
where, in the groups G¹ to G⁶, Ar represents a group of formula (6) or (7) 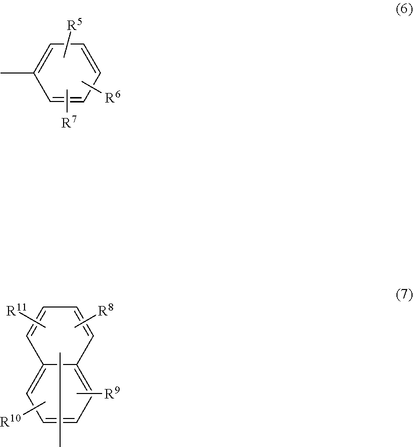
where
R⁵ to R¹¹ each independently have one of the meanings G⁸ to G¹¹ or represent a group of formula (8) 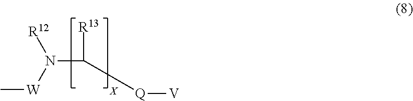
where
W represents a group of formula (1), (3) or (9) 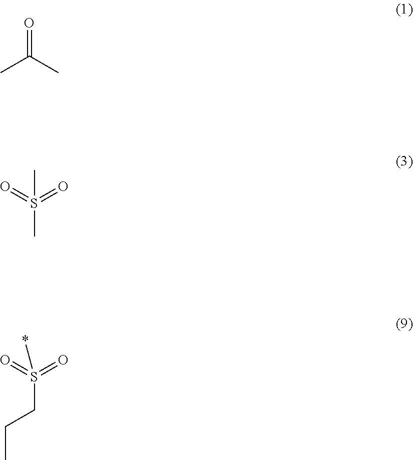
and * indicates the bond to the —NR¹² group;
R¹² represents hydrogen, aryl, (C₁-C₃₅)-alkyl, (C₂-C₃₅)-alkyl interrupted by one or more hetero atoms, (C₂-C₃₅)-acyl; cyclo(C₃-C₈)-alkylcarbonyl, arylcarbonyl, (C₁-C₃₅)-alkoxycarbonyl; aryloxycarbonyl; (C₁-C₃₅)-alkylsulfonyl, arylsulfonyl monohydroxy-(C₁-C₃₅)-alkyl, polyhydroxy-(C₂-C₃₅)-alkyl, (C₁-C₃₅)-alkoxyalkyl or aryloxy-(C₁-C₃₅)-alkyl;
R¹³ represents hydrogen, (C₁-C₁₅)-alkyl, singly or multiply oxygen-interrupted (C₂-C₁₅)-alkyl, aryl, aryl-(C₁-C₁₅)-alkyl, (C₁-C₁₅)-alkyl-aryl, aryloxy, (C₁-C₁₅)-alkoxy, monohydroxy-(C₁-C₁₅)-alkyl or polyhydroxy-(C₂-C₁₅)-alkyl and can have identical or different meanings within a molecule of formula (I);
x represents a number from 1 to 35;
V represents hydrogen, hydroxyl, amino, mono-(C₁-C₃₅)-alkylamino, bis-(C₁-C₃₅)-alkylamino, (C₁-C₃₅)-alkyl, aryl, aryloxy, (C₁-C₃₅)-alkoxy, monohydroxy-(C₁-C₃₅)-alkyl, polyhydroxy-(C₂-C₃₅)-alkyl or (C₁-C₃₅)-alkyl-aryloxy;
Q represents a group of formula (10) 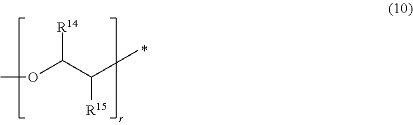
where
* indicates the bond to the V group;
R¹⁴ and R¹⁵ each independently represent hydrogen, (C₁-C₃₅)-alkyl, singly or multiply oxygen-interrupted (C₂-C₃₅)-alkyl, aryl, aryloxy, (C₁-C₃₅)-alkoxy, monohydroxy-(C₁-C₃₅)-alkyl or polyhydroxy-(C₂-C₃₅)alkyl and have identical or different meanings within a molecule of formula (I) and where when R¹⁴ and R¹⁵ have different meanings within a molecule of formula (I) these different meanings are randomly distributed or regions of respectively identical meanings follow each other;
r represents a rational number from 0 to 200 and has identical or different meanings within a molecule of formula (I);
G⁸ represents hydrogen, (C₁-C₃₅)-alkyl; trifluoromethyl; cyclo-(C₃-C₈)-alkyl; aryl; heteroaryl;
heterocycloalkyl; halogen; cyano; nitro; hydroxyl; (C₁-C₃₅)-alkoxy; aryloxy; (C₂-C₃₅)-acyl; cyclo-(C₃-C₈)-alkylcarbonyl, arylcarbonyl, (C₂-C₃₅)-acyloxy; arylcarbonyloxy; (C₂-C₃₅)-acylamino; (C₁-C₃₅)-alkylsulfonylamino; arylsulfonylamino; arylcarbonylamino; carbamoyl; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monoaryl-carbamoyl; N,N-diaryl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; aryloxycarbonyl; amino; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monoaryl-amino; diaryl-amino; monocyclo-(C₃-C₈)-alkylmonoarylamino; mono-(C₁-C₃₅)-alkylmonoaryl-amino; aminothiocarbonylamino; aminocarbonylamino; sulfamoyl; N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monoaryl-sulfamoyl; N,N-diaryl-sulfamoyl; N-monocyclo-(C₃-C₈)-alkyl-N-monoarylsulfamoyl; N-mono-(C₁-C₃₅)-alkyl-N-monoarylsulfamoyl; aminosulfonylamino; (C₁-C₃₅)-alkylthio; arylthio; (C₁-C₃₅)-alkylsulfonyl or arylsulfonyl;
G⁹ represents (C₂-C₃₅)-alkyl; (C₂-C₃₅)-alkoxy; (C₂-C₃₅)-acyl; (C₂-C₃₅)-acyloxy; (C₂-C₃₅)-acylamino; (C₂-C₃₅)-alkylsulfonylamino; N-mono-(C₂-C₃₅)-alkyl-carbamoyl; N,N-di-(C₂-C₃₅)-alkyl-carbamoyl; N-mono-(C₂-C₃₅)-alkyl-N-monoarylcarbamoyl; (C₂-C₃₅)-alkoxycarbonyl; mono-(C₂-C₃₅)-alkyl-amino; di-(C₂-C₃₅)-alkyl-amino; mono-(C₂-C₃₅)-alkylmonoaryl-amino; N-mono-(C₂-C₃₅)-alkyl-sulfamoyl; N,N-di-(C₂-C₃₅)-alkyl-sulfamoyl; N-mono-(C₂-C₃₅)-alkyl-N-monoarylsulfamoyl; (C₂-C₃₅)-alkylthio or
(C₂-C₃₅)-alkylsulfonyl where the alkyl radical is interrupted by one or more hetero atoms or one or more hetero atom groups;
G¹⁰ represents (C₁-C₃₅)-alkyl; cyclo-(C₃-C₈)-alkyl; heterocycloalkyl; (C₁-C₃₅)-alkoxy; (C₂-C₃₅)-acyl; cyclo-(C₃-C₈)-alkylcarbonyl; (C₂-C₃₅)-acyloxy; (C₂-C₃₅)-acylamino; (C₁-C₃₅)-alkylsulfonylamino; N-monocyclo-(C₃-C₈)-alkyl-carbamoyl; N-mono-(C₁-C₃₅)-alkyl-carbamoyl; N,N-dicyclo-(C₃-C₈)-alkyl-carbamoyl; N,N-di-(C₁-C₃₅)-alkyl-carbamoyl; N-monocyclo-(C₃-C₈)-alkyl-N-monoarylcarbamoyl; N-mono-(C₁-C₃₅)-alkyl-N-monoarylcarbamoyl; (C₁-C₃₅)-alkoxycarbonyl; monocyclo-(C₃-C₈)-alkyl-amino; mono-(C₁-C₃₅)-alkyl-amino; di(cyclo)-(C₃-C₈)-alkyl-amino; di-(C₁-C₃₅)-alkyl-amino; monocyclo-(C₃-C₈)-alkylmonoarylamino; mono-(C₁-C₃₅)-alkylmonoaryl-amino;
N-monocyclo-(C₃-C₈)-alkyl-sulfamoyl; N-mono-(C₁-C₃₅)-alkyl-sulfamoyl; N,N-dicyclo-(C₃-C₈)-alkyl-sulfamoyl; N,N-di-(C₁-C₃₅)-alkyl-sulfamoyl; N-monocyclo-(C₃-C₈)-alkyl-N-monoarylsulfamoyl; N-mono-(C₁-C₃₅)-alkyl-N-monoarylsulfamoyl; (C₁-C₃₅)-alkylthio or (C₁-C₃₅)-alkylsulfonyl where the alkyl radical is substituted by one or more G⁷ substituents;
G¹¹ represents G⁹ where the alkyl radical is substituted by one or more G⁷ substituents;
where, in the groups G⁷ to G¹¹, aryl represents a group of formula (11) or (12) 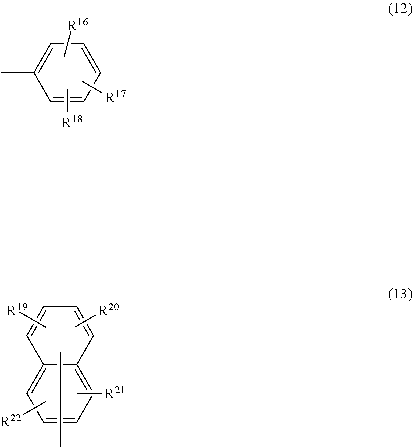
where
R¹⁶ to R²² each independently represent the G¹² group; and
G¹² represents hydrogen; (C₁-C₁₈)-alkyl; monohydroxy-(C₁-C₁₈)-alkyl; polyhydroxy-(C₂-C₁₈)-alkyl; (C₁-C₁₈)-alkyl interrupted by one or more oxygen atoms; trifluoromethyl; cyclo-(C₃-C₈)-alkyl; heteroaryl; heterocycloalkyl; halogen; cyano; nitro; hydroxyl; (C₁-C₁₈)-alkoxy; (C₂-C₁₈)-acyl; cyclo-(C₃-C₈)-alkylcarbonyl, (C₂-C₁₈)-acyloxy; (C₂-C₁₈)-acylamino; (C₁-C₁₈)-alkylsulfonylamino; carbamoyl; N-monocyclo-(C₃-C₈)-alkyl-carbamoyl; N-mono-(C₁-C₁₈)-alkyl-carbamoyl; N,N-dicyclo-(C₃-C₈)-alkyl-carbamoyl; N,N-di-(C₁-C₁₈)-alkyl-carbamoyl; (C₁-C₁₈)-alkoxycarbonyl; amino; monocyclo-(C₃-C₈)-alkyl-amino; mono-(C₁-C₁₈)-alkyl-amino; di(cyclo)-(C₃-C₈)-alkyl-amino; di-(C₁-C₁₈)-alkyl-amino; aminothiocarbonylamino; aminocarbonylamino; sulfamoyl; N-monocyclo-(C₃-C₈)-alkyl-sulfamoyl; N-mono-(C₁-C₁₈)-alkyl-sulfamoyl; N,N-dicyclo-(C₃-C₈)-alkyl-sulfamoyl; N,N-di-(C₁-C₁₈)-alkyl-sulfamoyl; aminosulfonylamino; (C₁-C₁₈)-alkylthio or (C₁-C₁₈)-alkylsulfonyl;
where
when X and T both represent a group of formula (1),
Y and Z do not both represent (C₁-C₃₅)-alkyl; a group of formula (6) where R⁵, R⁶ and R⁷ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino, (C₁-C₃₅)-alkylthio, (C₂-C₃₅)-acyl, benzoylamino or benzenesulfonylamino; or a methyl or ethyl group substituted by a group of formula (7) where R⁴, R⁵ and R⁶ each independently represent hydrogen, halogen, nitro, (C₁-C₃₅)-alkyl, (C₁-C₃₅)-alkoxy; mono-(C₁-C₃₅)-alkylamino, di-(C₁-C₃₅)-alkylamino or (C₁-C₃₅)-alkylthio;
and it is not the case that one of Y and Z represents (C₁-C₃₅)-alkyl and the other represents hydrogen; and
when X and T both represent a group of formula (2),
Y and Z do not both represent (C₁-C₃₅)-alkyl; (C₁-C₃₅)-alkyl substituted by halogen, (C₁-C₃₅)-alkylsulfonyl, substituted or unsubstituted benzenesulfonyl, or a group of formula (6) where R⁵, R⁶ and R⁷ independently represent hydrogen, halogen, (C₁-C₃₅)-alkyl or (C₁-C₃₅)-alkoxy; a group of formula (6) where R⁵, R⁶ and R⁷ each independently represent hydrogen, halogen, nitro, cyano, (C₁-C₃₅)-alkyl, (C₁-C₃₅)-alkoxy or aryl; or substituted or unsubstituted benzoyl; and
when X and T both represent a group of formula (3),
Y and Z do not both represent a group of formula (6) where R⁵, R⁶ and R⁷ each independently represent hydrogen, halogen, nitro, (C₁-C₃₅)-alkyl, (C₁-C₃₅)-alkoxy; (C₂-C₃₅)-acyl, benzoylamino or benzenesulfonylamino.
